(19) United States
(12) Patent Application Publication
(10) Pub. No.: US 2006/0069685 A1
(43) Pub. Date: Mar. 30, 2006

(54) Method and a process, provided through internet based software, for the development, management, and reporting of information regarding contingent liabilities

(76) Inventors: Tom Alan Dickens, Houston, TX (US); Oliver William Scoble III, Houston, TX (US)

Correspondence Address: Tom A. Dickens, 14922 Inverrary, Houston, TX, 77095, US

(21) Appl. No.: 10/939,563

(22) Filed: Sep. 14, 2004

(51) Int. Cl. G06F 17/30

(52) U.S. Cl. 707/10

(57) ABSTRACT

The software meets the needs of the people involved in the management and handling of contingent liabilities including attorneys, adjusters, clients, CEO, CFO, and auditors. Remote secure access with variable user rights can be controlled and monitored giving each authorized user, including the client, remote secure access to audit quality information, including finished documents, which is developed and maintained in a format that is Sarbanes-Oxley compliant. The software allows all of those involved in the handling and mangement of contingent liabilities (both litigaiton and claims) to utilize the same software and therefore be capable of sharing and transfering information automatically. In addition to the accessability of information which is maintained by an internet service provider and accessed through an internet connection, the format of the software allows complete case/claim management in a format which inhances user productivity by providing a single software solution incorporating the management of opinions, facts, reserves, deadlines, pleadings, activity, parties, expert witnesses, fact witnesses, vendors, attorneys, adjusters, budgets, menu-task billing scheudles, court scheduling orders, discovery, motions, records, evidence, evaluations, authority, negotiations, settlements, expenses, document generation and Sarbanes-Oxley compliance.

### BACKGROUND OF THE INVENTION

1. Field of the Invention

This invention relates to the automation of litigation, claims and legal matter management through the use of an internet based software solution which is used by and meets the individual distinctive needs of the adjusting companies, law firms, and clients from the risk manager to the CEO.

The software provides both the means and the method for the clients to manage, control and report contingent laibilities from the information as it is developed by the attorneys and adjusters handling the matters. This is accomplished through the integration of the features, many of which are unique to the software, and data management processes that allow the clients to directly access audit quality detailed information, interact with the handling attorney or adjuster all with controlled client user access rights. The software is not reporting software it is productivity enhancing software which stores information in a manner and in a format that allows a variety of client access options to multiple backends at one time allowing exhaustive comprehensive reporting which eliminates many of the tasks that clients are now performing manually and allowing the client to produce many items, including case summaries, satutus reports, performance reports showing the firms have met the client's deadlines, performance criteria, and much more.

2. Description of Prior Art

The handling of claims and litigation (this reference includes pending legal matters where a client has retained an attorney but does not involved an adversary proceeding or a lawsuit) itself has always been a cumbersome task that stood separate and apart from the task of reporting to and interacting with the clients. Client reporting, which includes not only status reports but also things like bills and budget reports, has previously been a very paper intensive function that has been automated at best by software which is nothing but reporting software that is substantially comprised of memo fields which are useless for flexible reporting, performance compliance reports and auditing. The shortcomings of these systems is that they were designed as reporting systems only, not work enhancement systems providing the detailed tools necessary for efficient work as well as flexible reporting and automated audit processes. The bottom line is that adjusters had their software, attorneys had some limited software and clients had their own software. Status reports were nothing but word processing doucments or a string of memo fields with activity information which required the cleints to extract the information manually that was important to them and then put it into their own distictively diferent systems in a completely different format. Our system and method unifies the information management needs for all three; attorneys, adjuster, and clients and provides unique solutions to many previously expensive or time consuming tasks.

The methodology that provides the immediate solution is the attorneys' and adjusters' ability to create audit quality detailed information as they develop the files or matters and then allow a cleint, or other designated third party, to securely and remotely access these audit quality details, regardless of who is handling those matters or where they are pending. This remote access allows the client, whether an individual, a company or insurance carrier, to review only their cases, even if the firm (adjusting or law) is handling numerous other clients' matters utilizing the same software. Because the client can generate reports from multiple back ends maintained by different firms the effeciencies are enormous. Previously, because of the limitations of computers, the limitations of software languages, the limitations/non-existence of the internet to host, this methodology had neither been attempted nor conceived. It was only because of the inventor's effort at developing this integration of features, logic and methodology has this method of handling and managing contingent liabilities not been addressed by prior technology or methodology. This software is not written in a manner making it dependent upon any other software except the operating system.

The prior technology consisted of reports created in word processing doucments to inform the clients and insurance carrier's of the status of claims and litigation. Prior technology did not allow for the integration of and sharing of information among adjusters, attorneys and carriers. Prior technology did not and has not allowed the client direct remote secure access to information to generate reports, generate bills, audit the lawyers' and adjusters' work, all with the same software. There was also no method for the client to implement controls and monitor the effectiveness of the controls over the attorneys' and adjusters' work. The audit processes performed by the client manually or by third parties at the cleints direction are now no longer required because of our automation of the audit process through the integration of work product tools, diary system, menu task billing system, and performance requirements; all of which are now integrated in a completely secure environment. This requirement is essential for companies to automate the process of meeting audit requirements as well as meet the new statutory requirments of The Sarbanes-Oxley Act of 2002.

The deficiency of the prior technology and methodology was that it was very labor intensive, expensive, cumbersome for not only the person handling the matters but the client, the person relying upon the reports from attorneys and adjusters was overwhelmed with paperwork and had to rely upon manual processes to review the work or had to outsource that review at tremendous expense with no way to automate the process because of the differences in the systems, if any, utilized by the attorneys, the adjusters and the clients.

The deficiencies of the prior technology was that there was no system to allow the information developed by the adjuster to be available for the attorneys use except by copying the file, sending it to the attorney and then the attorney enters the information. That is not a requirement with our software because the information can be imported from one backend to another. There was no system controls to be put in place with audited attorneys and adjuster's time entries both at the time of entry and along with the bill or status report to ensure compliance with budgets, menu task billing guidelines, the existence of prior authority when required, and many other tasks that were labor intensive and expensive.

Prior art did not allow a client to generate information from multiple law firms or adjusting companies handling their files anywhere in the world. For example, if a client wanted to know every trial date in every state in the US or in every country where there is pending litigation, it would be a very labor intensive task to pull that information and then to assimilate it into one report. Another example of the shortcomming would be in the instance the client wanted to determine the claims or cases where there were settlement opportunities, based for example on how close the demands were to the value set by the client. This is a very labor intensive task that requires written reports from each firm or company handling the matters, an assimilation of the information and then manual identification of individual cases. By the time this was accomplished even on a small scale the information gathered may very well be outdated.

Prior art also dependend upon multiple entries of the same information for the client, attorney and adjuster. Multiple entries are expensive and lead to errors and mistakes.

There is also a problem with the prior art on a very basic level, clients are no longer willing to pay for many clerical or administrative tasks that are required to be performed to develop the matters. The automation is necessary to remain competitive and profitable under the restraints of the practice in the current environment.

### SUMMARY OF THE INVENTION

The primary object of the invention is provide a single software solution to meet the needs of the attorneys, adjusters, as well as the needs of the clients', from the risk manager to the CEO. This objective is met by allowing the client remote secure access to audit quality information as developed by the attorneys and adjusters in the handling of those matters with the information in a format automating many of the audit and reporting requirements of clients, which combined with the unique features and detailed structure of the information in a unique format, which overcome or solve the problems of the prior technology while meeting the requirements of auditors.

Another objective of the invention is the software allows all of those involved in the handling and mangement of contingent liabilities to utilize the same software and therefore be capable of sharing and transfering information automatically.

Another objective of the invention is to allow a single law firm or adjusting company to utilize back end for data storage for all of their clients, maximizing the firm's effeciencies, while allowing the clients restricted access to information regarding their claims or cases only.

Another objective of the invention is to allow the information on each of the matters being handled to be developed in a format that does not require extra work steps or process to be utilized by the clients for review and for all of the audit features eliminating the need for duplicate work when sofware simply reports as opposed to enhancing user productivity.

Another objective of the invention is the integration of the tools required for the adjuster and the attorney. Many of the tools are duplicated but since there are unique features for the adjuster, such as setting reserves, and for the attorney, producing witness lists, the software provides the solution by providing all of these features in a format that easily allows unneeded features to be ignored or for some users the ability to allow both the adjuster and the attorney to utilize the same backend and share the development of a case or claim.

Another objective of the invention is to allow companies listed on the SEC and who report contingent liabilities on their balance sheets to be able to handle those contingent liabilities in a manner consistent with Sarbanes-Oxley.

Another objective of the invention is remote secure audits performed from a single location on each and every case pending worldwide.

Another objective of the invention is for the ability to implement and enforce controls regarding the handling of contingent liabilities.

Another objective of the invention is to monitor the effectiveness of controls placed on the handling of contingent liabilities.

Another objective of the invention is to report on the effectiveness of those controls placed on the handling of contigent liabilities.

Another objective of the invention is to export the data and information relevant to those control measure and steps in a format that is compatable with the auditor's requirements.

Another objective of the invention is to allow the same controls and audit procedures to be used equally as well with nonligation as with litigation.

Another objective of the invention is for a law firm or adjusting company to allow a variety of access options to multiple clients for information only on their cases including key word processing documents.

Another objective of the invention is to allow client reporting from a variety of format options capable of pulling information from a single back end or multiple back ends (each law firm, adjusting company, or company which utilizes the software has their own back end where their data is stored) thereby allowing the monitoring of performance and the ability to obtain summary information from a user selected area, region or group of firms or adjusting companies handling their matters.

Another objective of the invention is to provide a method and process to analyze, index, report, collate, and sumarize information contained in records, pleadings, discovery, statements, depositions or any other written material in a format that containes both fixed and variable information topics to be analyzed which can be used for pretrial evaluation and during the litigation process.

Another objective of the invention is a method and a process for reporting for not only information purposes but to determine the performance level of firms handling legal and claims matters. Performance levels includes both noncompliance and compliance with performance standards and requirements both in the billing and in the development of the matters being handled.

### DESCRIPTION OF THE DRAWINGS

The drawings constitute a part of this specification and include exemplary embodiments to the invention, which may be embodied in various forms.

FIG. 1: This is a diagram of the structure of the software when utilized by multiple law firms and adjusting companies who are each providing services to multiple clients.

FIG. 2: A screen shot demonstrating the method and the system for adding field(s) to a given case or to build field groups to add as a group to any case. This is a unique and distinctive feature of our software.

FIG. 3: A screen shot demonstrating the method and the system which allows the user or the remote access client to add a record indicating authority of an adjuster or an attorney to make an offer. This is a unique and distinctive feature of our software in that it follows the format of typical insurance coverage, allowing for the different categories of damages to be evaluated, and the record can be added by the client directly to the attorneys' or the adjusters' data.

FIG. 4: A screen shot demonstrating the method and the system which gives the user the ability to add a record indicating the evaluation of an adjuster, attorney or client. This is a unique and distinctive feature of our software in that it follows the format of typical insurance coverage, allowing for the different categories of damages to be considered in the evaluation, and the record can be added by the client directly to the attorneys' or the adjusters' data. All of this information is stored historically and it is an integral part of the audit features.

FIG. 5. This is tab #2 of FIG. 4 which references bodily injury.

FIG. 6. This is tab #3 of FIG. 4 which references property damage.

FIG. 7. This is tab #4 of FIG. 4 which references other damage.

FIG. 8. This is a screen shot demonstrating the method and the system to allow the system user or administrator to set the billing cycle and the identification of the person to be billed. This is integrated with the information management system regarding individuals who have been added to a specific case. This logic is unique to our software.

FIG. 9. A screen shot demonstrating the method and the system which give the user, including a remote client user, the ability to add a record adding to or reducing the budget that is available for the adjuster or the attorney to develop the legal matter. This is a unique and distinctive feature of our software in that it allows a budget to be set for the total amount, for individual categories or for both. This budget formation is distinctive in that it matches the menu task billing schedule that is selectively associated with a specific case.

FIG. 10: A screen shot demonstrating the Case Activity Record which is integrated into the diary system, the warning system, the billing system, the menu task billing system, the automated point of entry audit system that corrects entries as they are made; the automatic conversion that converts minutes to portions of an hour, the innovative link to the document filings system which enable time on any specific document or project to be tracked, and the innovative memo field which records the date information was first entered and the date last edited. The incorporation of all of these features into one record while linked to so many functions is innovative.

FIG. 11 A screen shot demonstrating the ability of the system administrator to add and edit menu task billing schedules consistent with the ABA codes and allowing for the unique addition of an infinite number of entries along with an infinite number of scheudle names. Each entry has the ability to designate the maximum hours, and/or the maximum fees that may be charged for a given task. This is uniquely integrated with the case activity schedule, the budget and the automated audit features. All of these are unique to the software.

FIG. 12: This is a screen shot of the main case screen which uniquely incorporates all of the features necessary for both the attorney and the adjuster. It also integrates with the system security system which allows an ifinite number of security combinations allowing an attorney or adjuster to customize the security access features through the “Case Section” and “Case SubSection” fields.

FIG. 13: This is a screen shot of the Court Information/Scheduling Order screen. The unique feature is that while it retains system wide informaiton regarding the courts, court personnel, and the clerk of the court it uniquely stores the documents and notes regarding critical pretrial and trial documents. The unique feature of storing the memo fields that can contain these notes is combined with the ability to store finished docuements for a client to review.

FIG. 14: This is a screen shot of the Scheduling Order screen. This screen has several innovative features both in the screen presented and in its interface with the case activity record/diary system. As can be seen each standard cutoff date has a place for the date. Beside the date is a “clock” picture. A click of the clock automates the creation of a case activity which incorporates the necessary information automatically to prevent clerical errors and automates the creation of 10, 30 and 60 day warnings for the cutoff date. It also incorporates a flexible date system to add cutoff dates whose titles cannot be anticipated.

FIG. 15: This is a screen shot of the “Discovery” table or record. This screen demonstrates innovative features. First of all this single record creates or triggers the diary warning system for responses which are due; provides the information necessary to print the cover sheet for the paper file; provides a unique memo field to actually store the entire document; automated generation of the record necessary to reflect receipt of a resonse and to generate the appropriate record, and again the ability to create an automated indivdidual case activity entry to diary future events. The “topic index” is a unique method to organize the information indexed within a discovery response and will be demonstrated separately.

FIG. 16: This is a screen shot of our method and system for tracking independent evidence or exhibits which are not part of any record, discovery document, pleading or other item related to the case. This allows a separate offer of evidence with the supporting summary necessary for offer of or objection to evidence at trial.

FIG. 17: This is a screen shot of our method and system for tracking all file expenses. It is integrated with the case so that information regarding parties, people and billing information.

FIG. 18: This is a screen shot of our method and system for completing the file organizational method, which in addition to organizing pleadings, discovery, and motions we also provide a vehicle for miscellaneous documents to be indexed and stored consistent with those other paper files. Again this is linked to the systems as discussed in FIG. 15.

FIG. 19: This is a screen shot of our method and system for completing the file organizational method, which in addition to organizing pleadings, discovery, and miscellaneous documents we also provide a vehicle for motions to be indexed and stored consistent with those other paper files. Again this is linked to the systems as discussed in FIG. 15.

FIG. 20: This is a screen shot of our method for handling information regarding negotiations. Reserves, authority, negotiations, and settlements are all related and dependent upon each other. For example, when an offer is made to pay, authority and reserves are automatically checked and, if the user chooses, automatically edited to ensure integrity of the information and the sufficiency of amounts. The various tabs for bodily injury, property damage and other damage are all consistent with each other. Additionally, it is automated to ensure only one “active” or current record and the calculations to show the total amount compared with the previous amount are all automated.

FIG. 21: This is the means and method for the automation of the authority, as referenced in FIG. 20, so that the authority amount can be automatically adjusted.

FIG. 22: This is the means and the method for the automation of the reserve amount, as referenced in FIG. 20, so that the reserve amount can be automatically adjusted.

FIG. 23: This is the means and the method for automatically limiting the right of a user to set reserves, which is a feature for the system administrator to set which is critical for the integrity of the reserve information.

FIG. 24: This is the means and the method for providing a unique and innovative tool, a tool unique in design to the software, which allows a party to be evaluated, to recreate a jury's opinion or verdict based upon detailed fact evaluation. Different types of damages can be evaluated and all historical information is maintained. The value is stored in terms of a range which is critical for the finanacial reporting of the client. This evaluation is an integral party of the ability to remotely perform audits and the ability to implement controls and performance standards for the attorney and for the adjuster by the client.

FIG. 25: This is the second screen of FIG. 24 which focuses on the individual elements of the evaluation. It is critical that the person doing the evaluation can disclose to the client the amounts claimed as well as the user's opinion as to the probable jury award.

FIG. 26: This is the third screen of FIG. 23. See FIG. 23-25.

FIG. 27: This is the third screen of FIG. 23. See FIG. 23-26.

FIG. 28: This is the fourth screen of FIG. 23. (see FIG. 23-27) This screen demonstrates the innovative means and method for applying the factors that a jury will consider and will influence a jury verdict. The qualtification of these factors into an evaluation tool is unique to the software.

FIG. 29. This is the fifth screen of FIG. 23 (see FIG. 23-28). This screen calculates the probable jury range regarding a specific claimant based upon the preselected criteria.

FIG. 30: This is the means and the method for providing a unique and innovative tool, a tool unique in design to the software, to keep track of records and the information in records. It is the first of five tabs for record information which include medical bills, lost wages, property damage and liens. This record information is integrated with system wide information. The information is broken down logically to facilitate client reporting and review, trial preparation, discovery responses, and also is capable of not only storing the record but the summary of the record.

FIG. 31: This is the second tab to FIG. 30. Tracking medical expenses past and future is basic to every evaluation but FIG. 32 makes this method and system unique to the handling of medical expense information.

FIG. 32: This is the medical expense detail referenced in FIG. 31. It is the means and the method for tracking detailed expenses, past and future and then lets you choose to automatically update the figures appearing on FIG. 31. Again, this type of detail is what makes the automation of the audit process possible. It allows these numbers to be totaled and compared to the party or jury evaluations to ensure there is sufficient support in a file to justify a certain amount of medical expenses, lost wages, and property damage. Further, this screen shot shows the means and the method for updating the expense amounts.

FIG. 33: This screen shot is the means and the method for handling information regarding any person in a case. It utilizes the unique feature of being able to designate an individual as someone in multiple roles within a case. It also utilizes system wide information to minimize typing or data input. The bottom of the screen with the yes/no boxes is integrated with the audit features which allows the automation of the audit of an individual file as well as multiple files being handled by different firms.

FIG. 34: This is a screen shot of the unique means and method for linking or associating any person involved in the case to a party or multiple parties. This feature allows the user to review and report on these relationships. For example, a user could generate a pretrial report which would show each and every fact witness designated by each individual party in the case. This is a task that is currently done manually with word processing doucments.

FIG. 35: This is the means and method for the warning system that is the heart of the diary system but it is uniquely connnected to multiple sources for the information. It is linked to the case activity system, the pleading records, the discovery records, the motion records, and the misc. filing records. All of these allow the user to select the level of warning. Additionally, the phone message system is interfaced with the billing and warning system so time is never lost or misplaced.

FIG. 36: This is the means and method to allow the user to select what users will view with regard to the warnings.

FIG. 37: This is the means and the method for the system administrator to be able to control a user's rights to specific cases or matters. The unique system is completely flexible in that it allows a variety of user rights to groups of cases but it also allows specific user rights to be controled and edited on each individual case.

FIG. 38: This is the screen shot indicating the means and the method for the “party cross index system” which is a unique short cut device allowing the user to be able to instantly identify the parties, the types of claims they have and who they are making claims against.

These and additional embodiment of the invention may now be better understood by turning to the folowing detailed description wherein an illustrated embodiment is described.

What is claimed is:

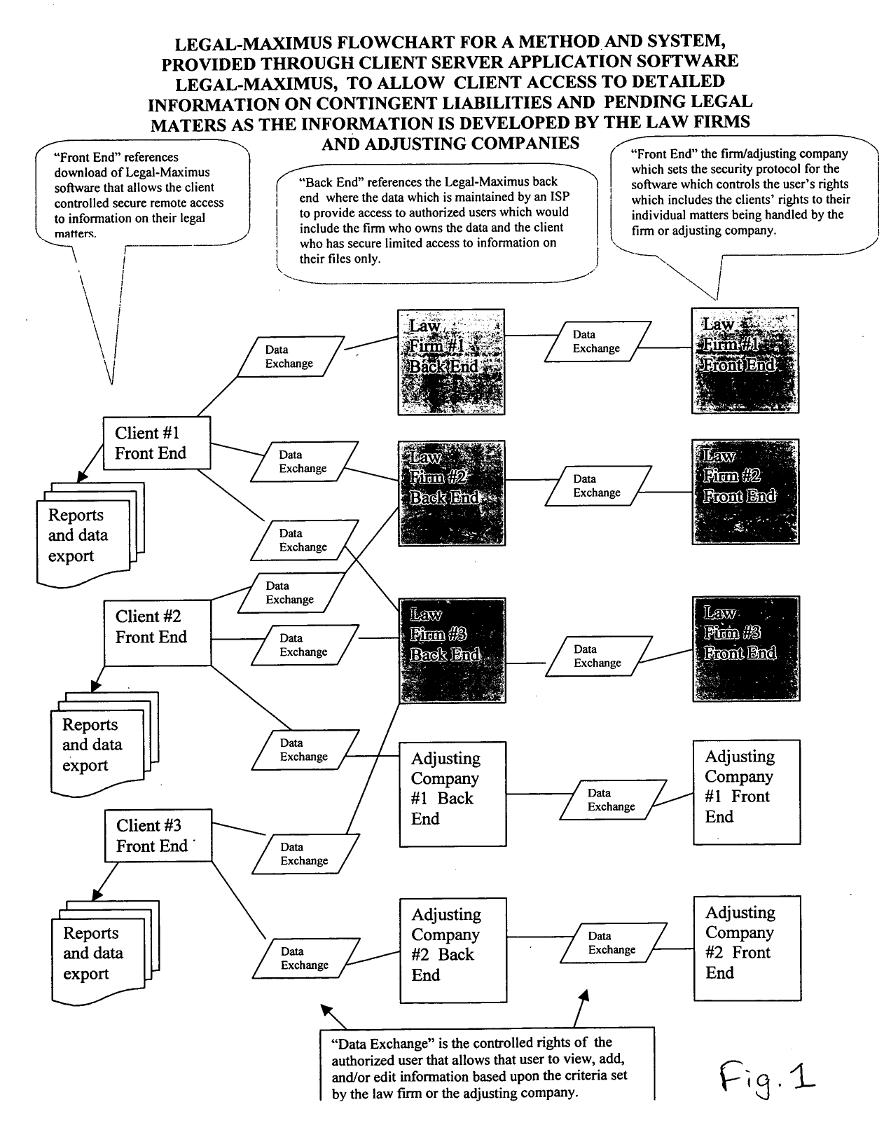

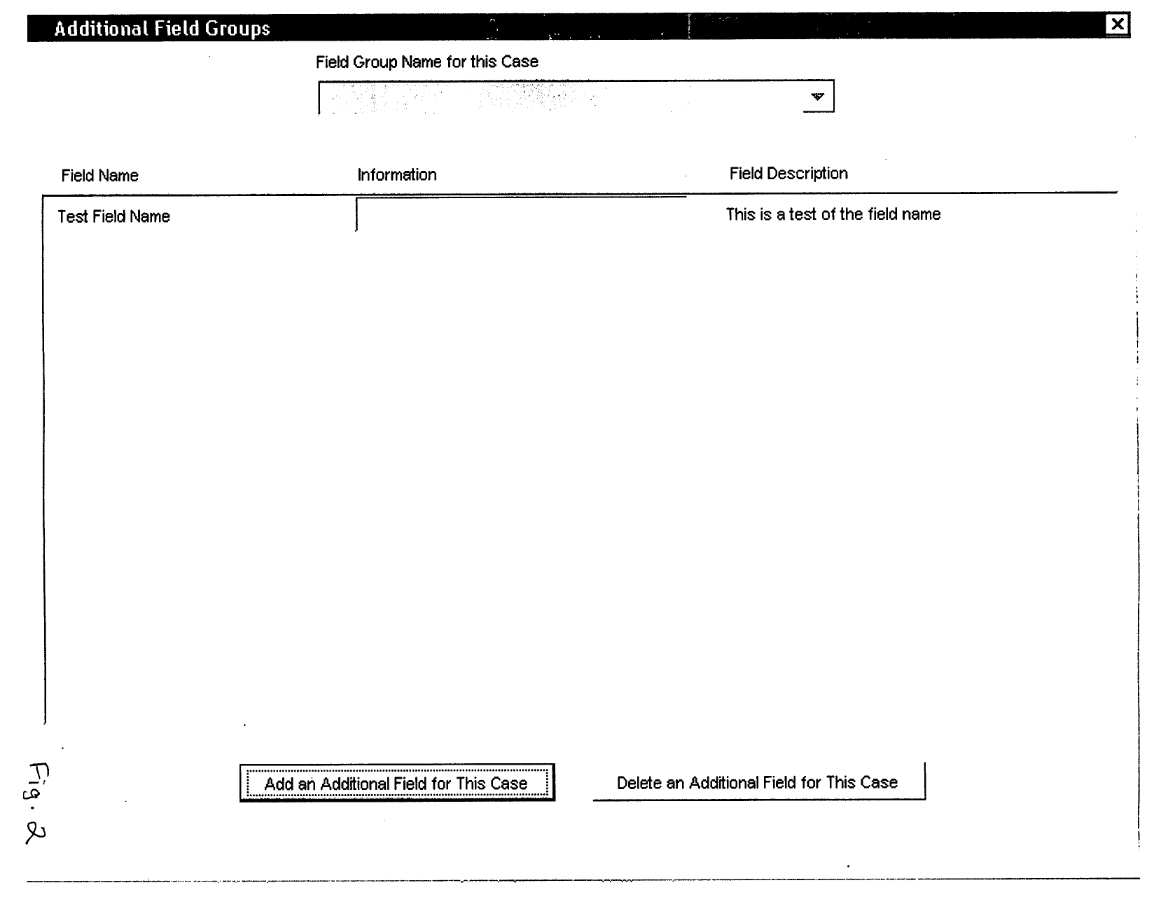

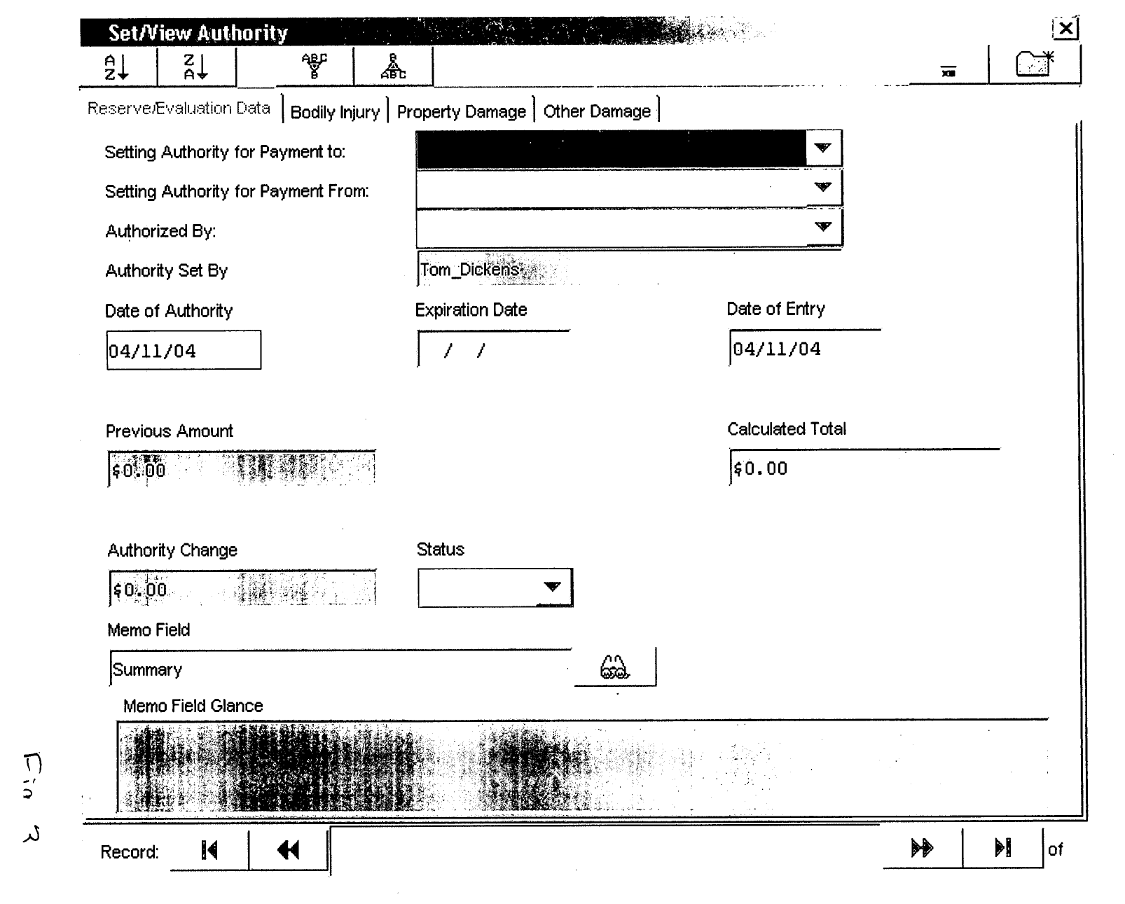

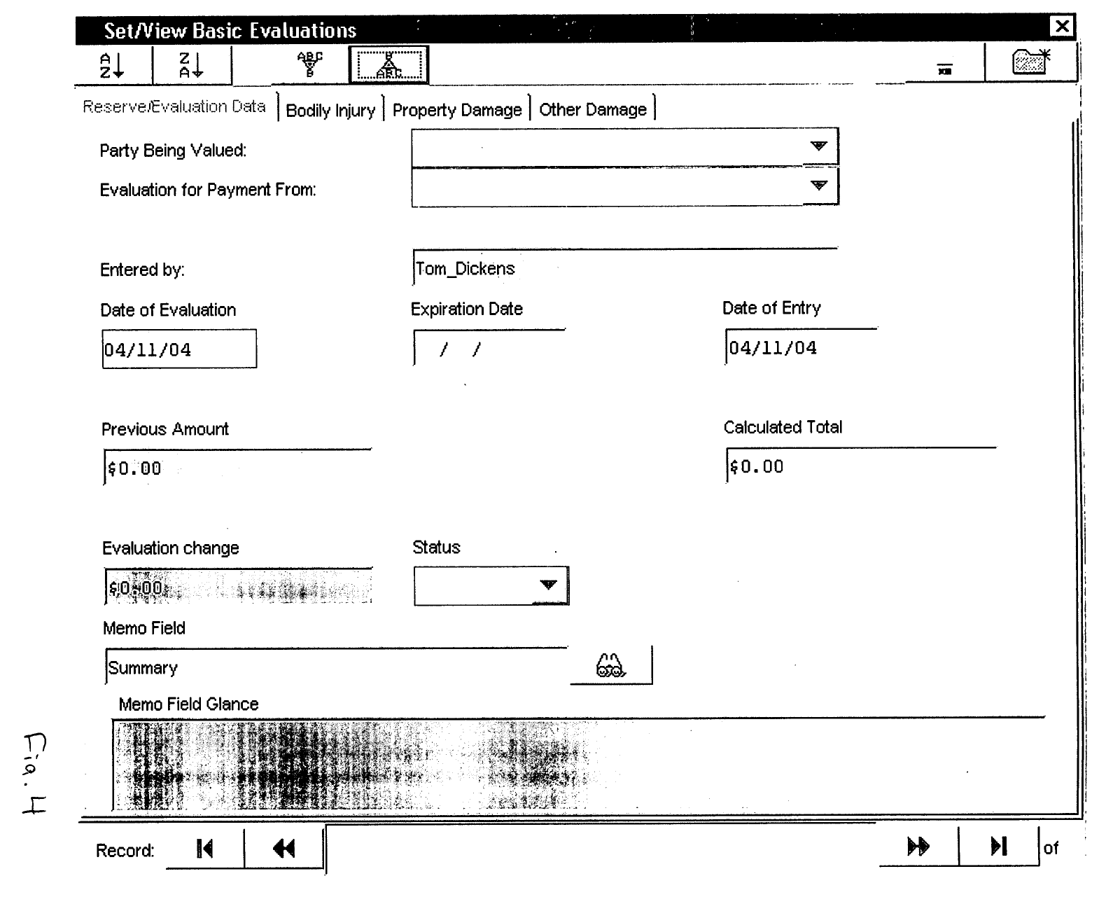

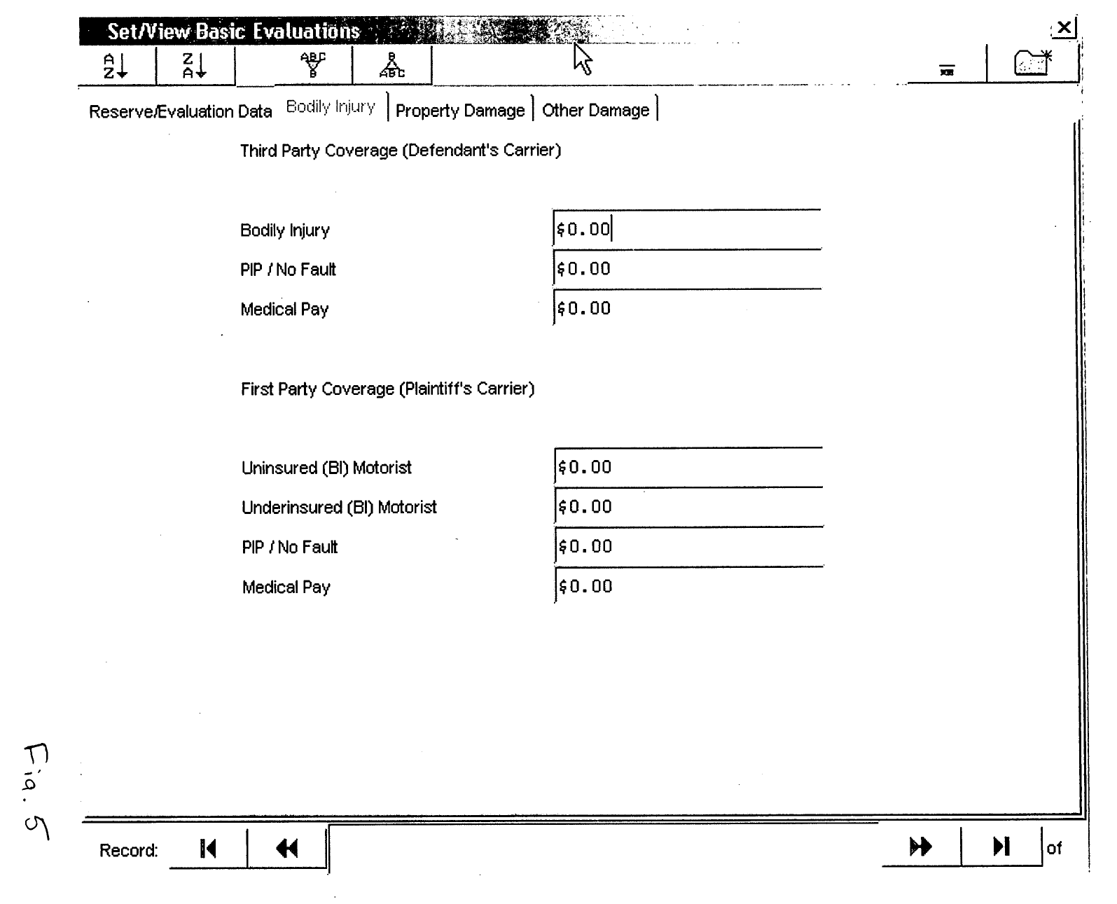

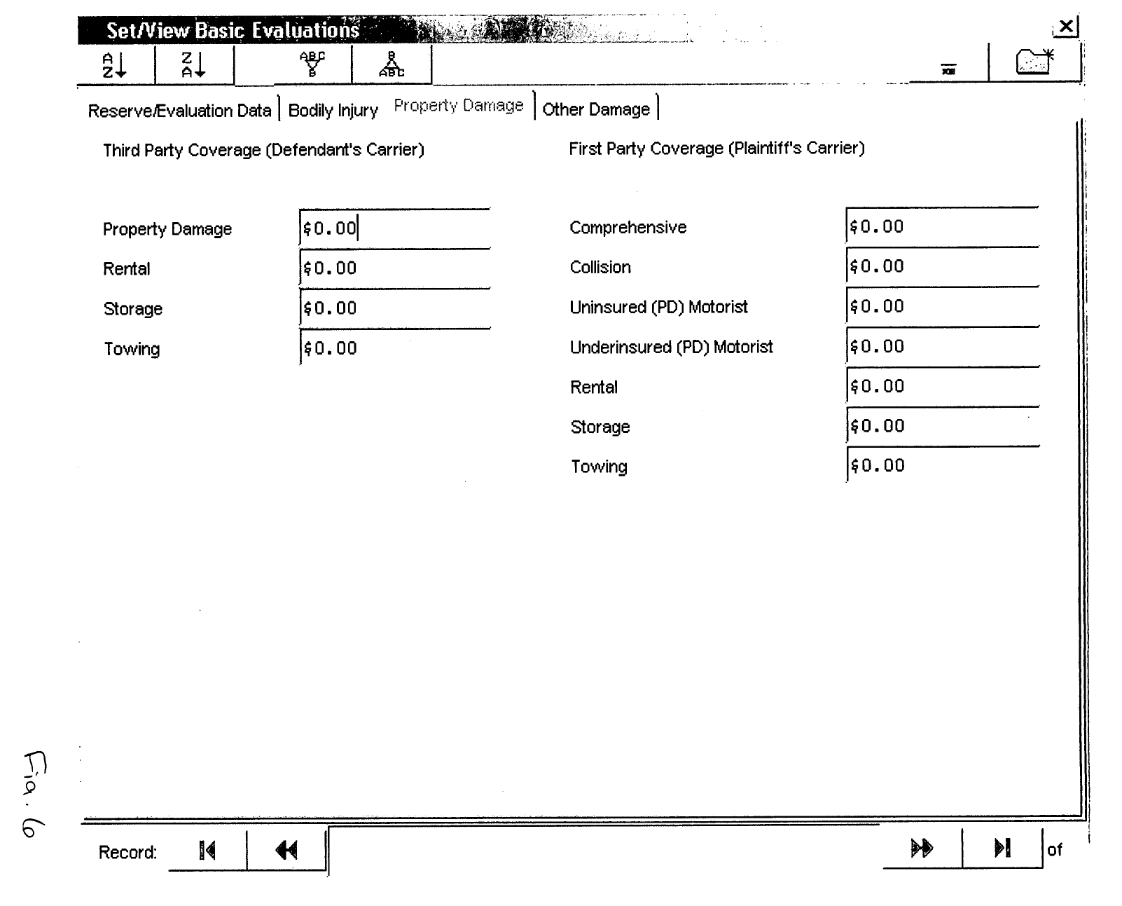

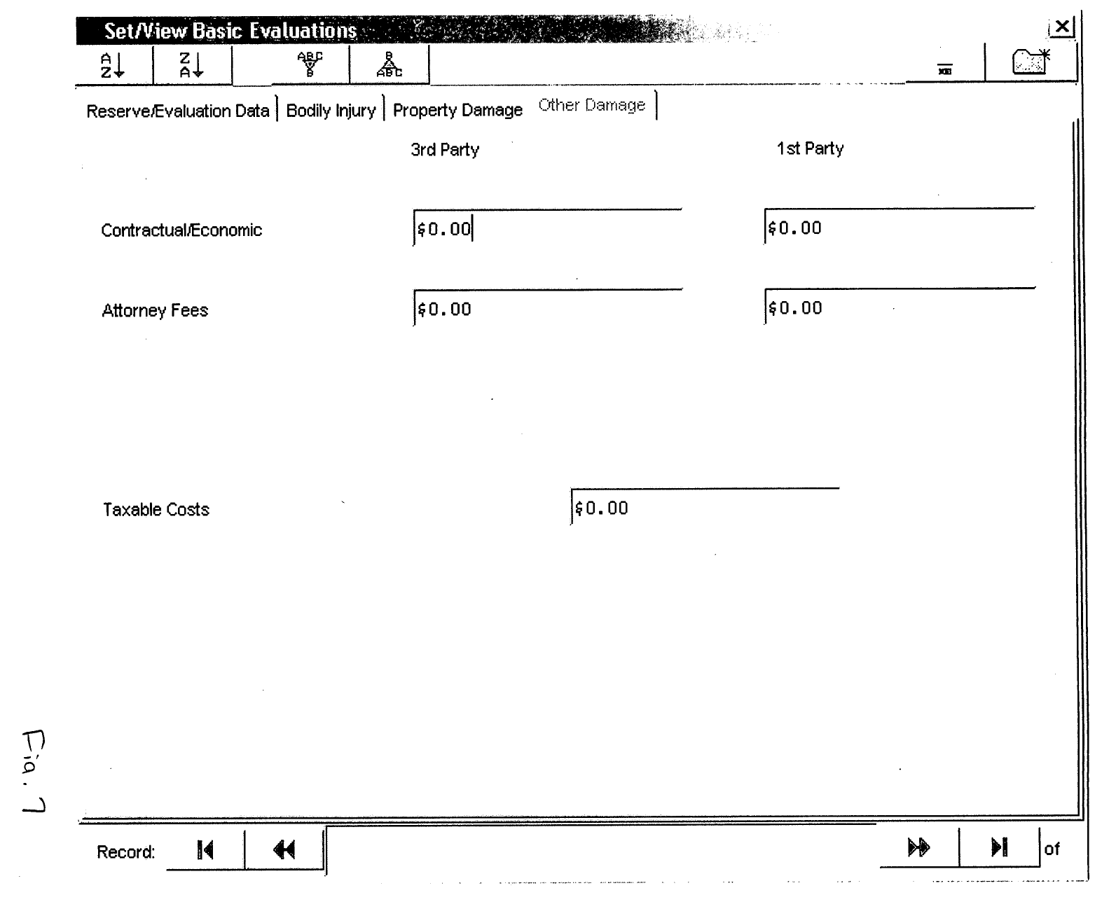

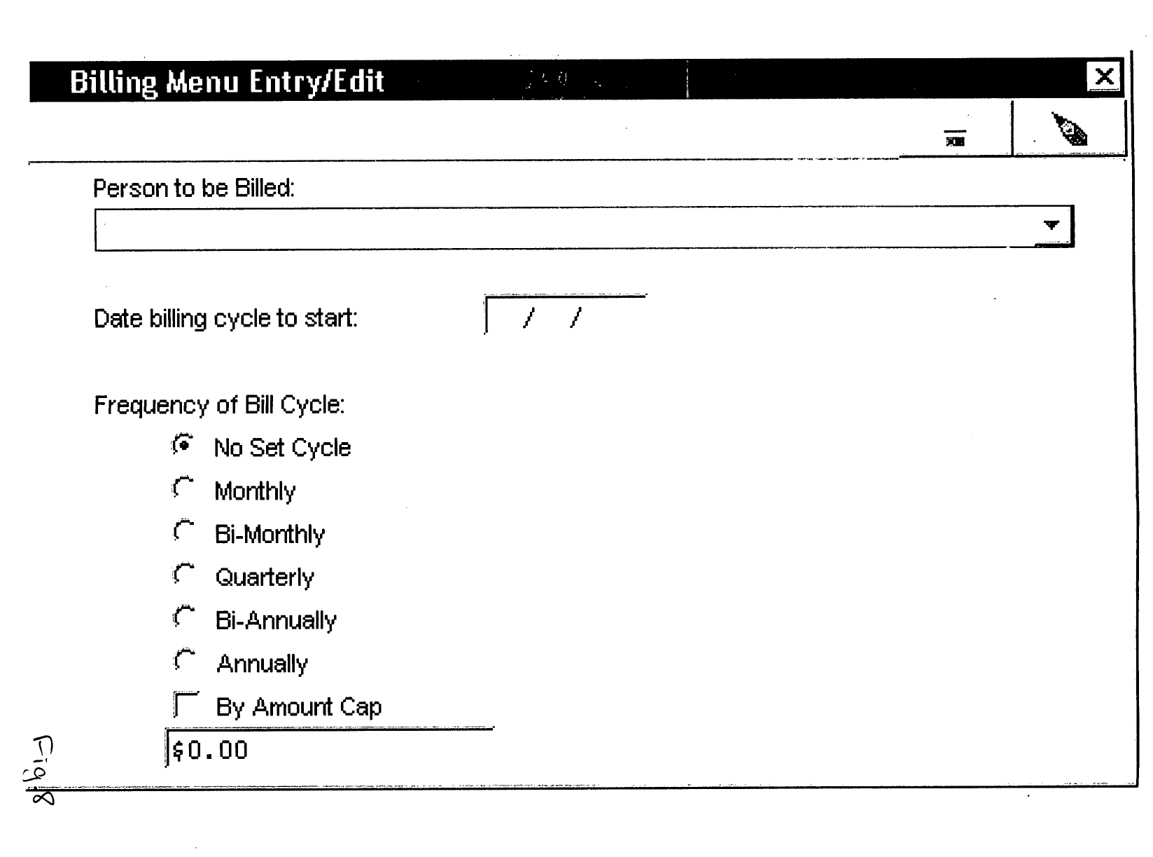

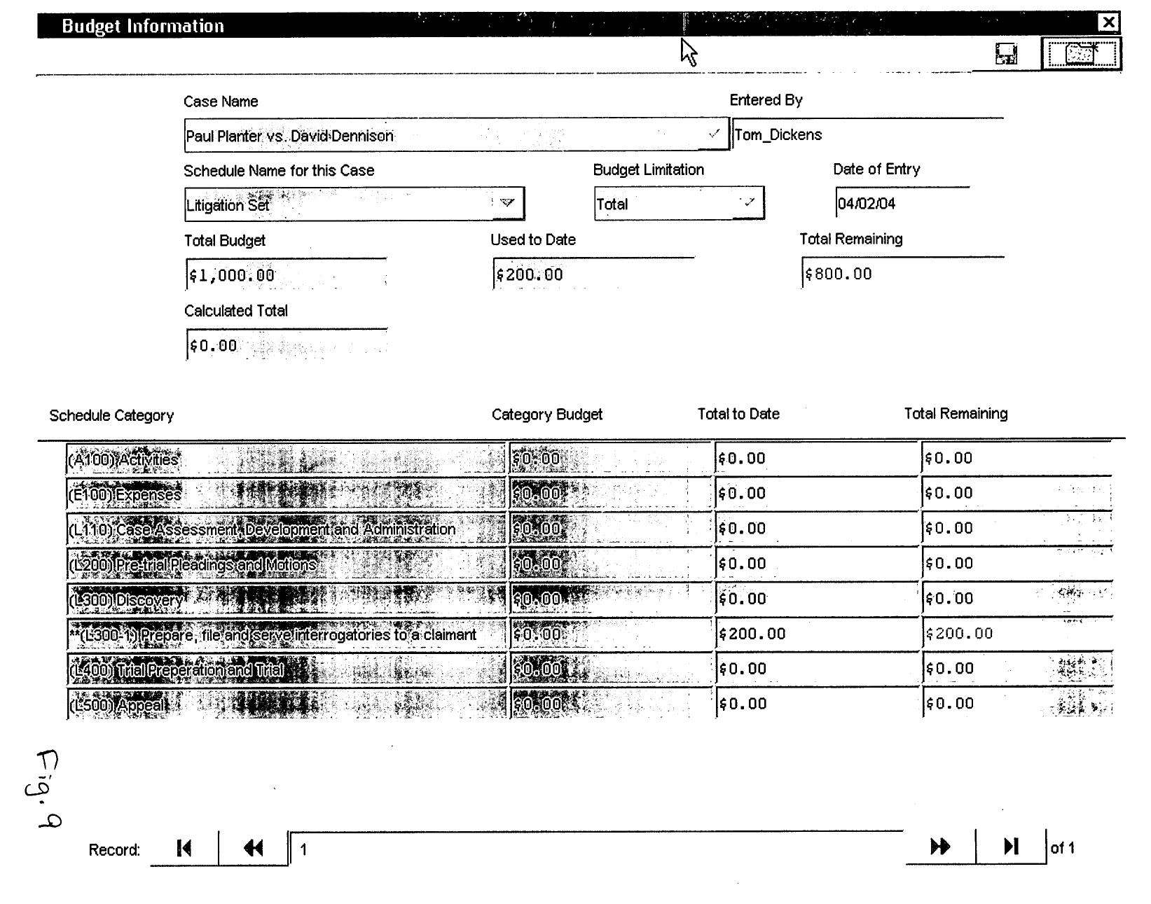

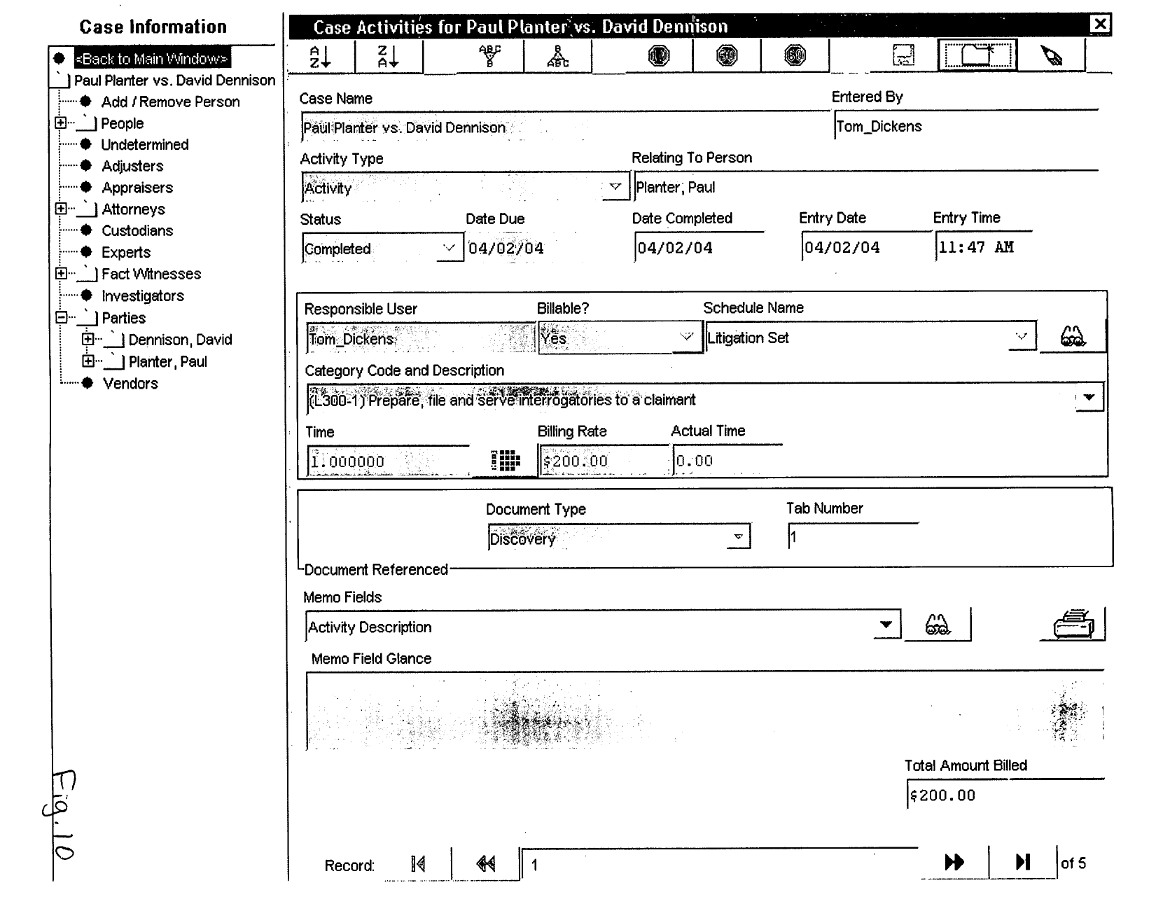

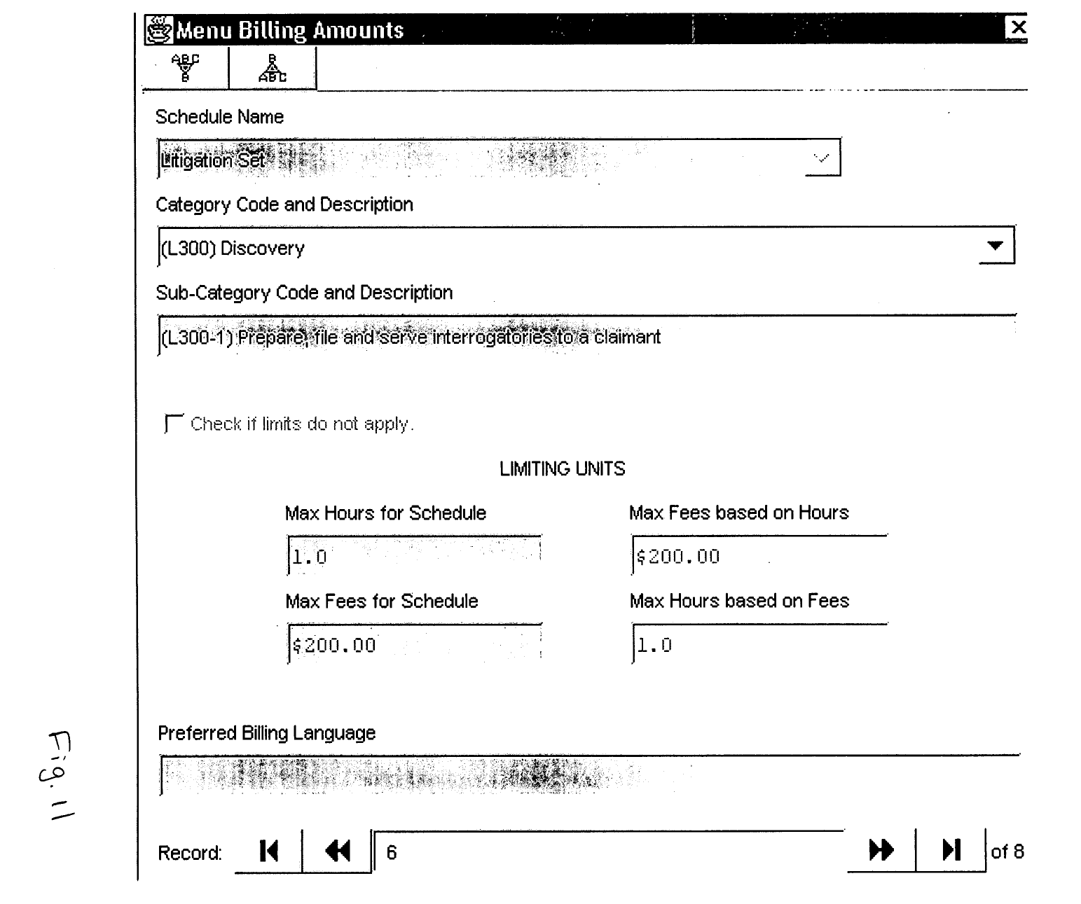

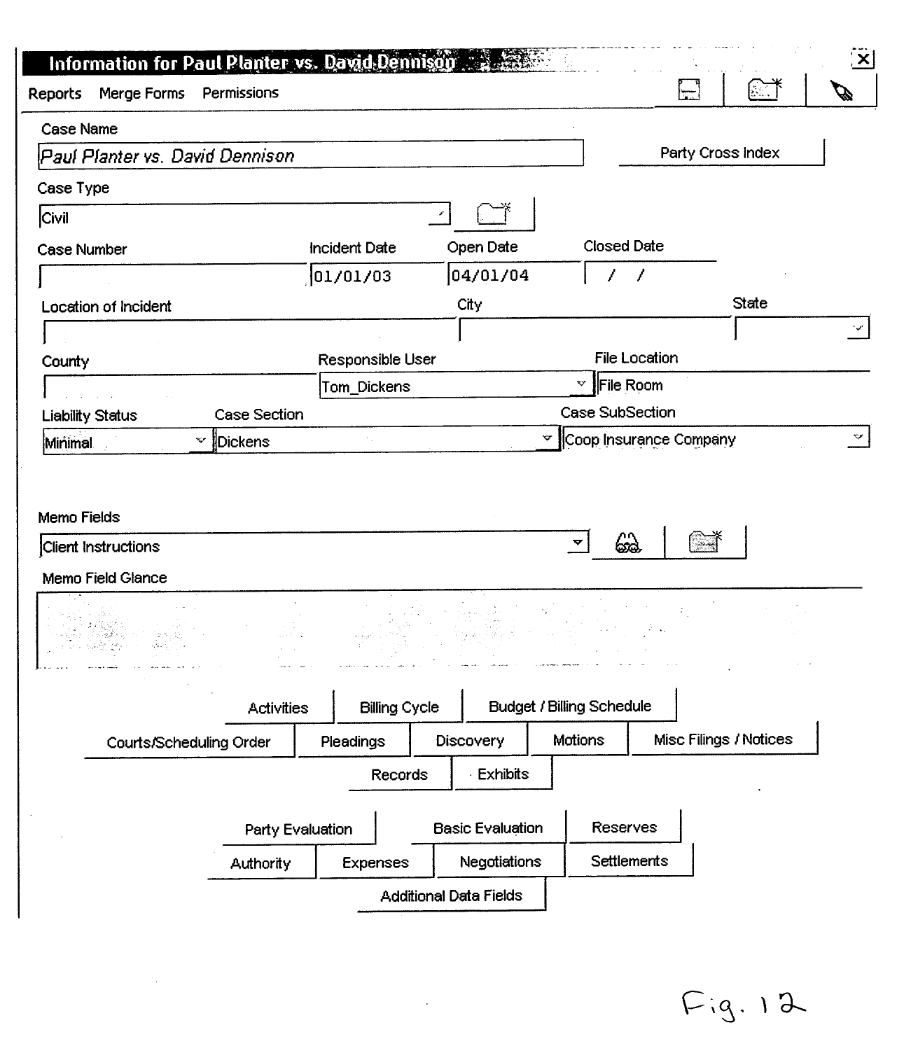

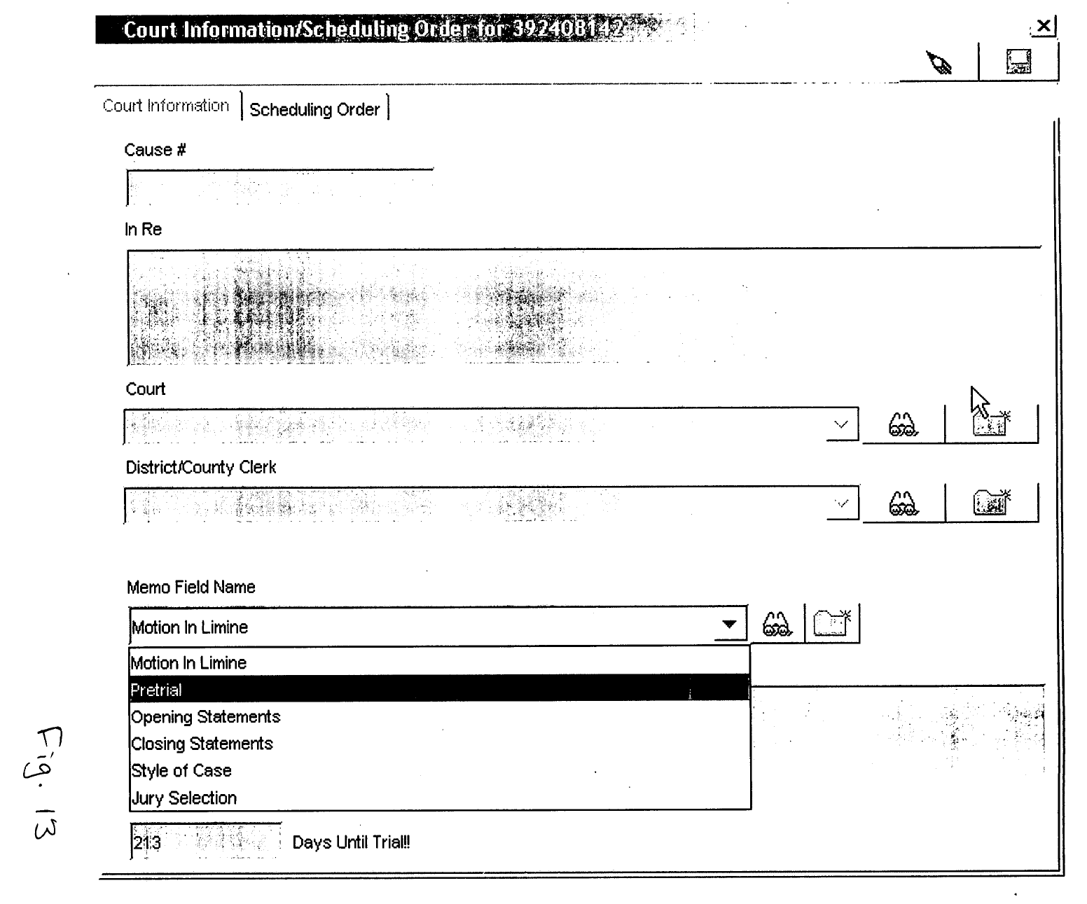

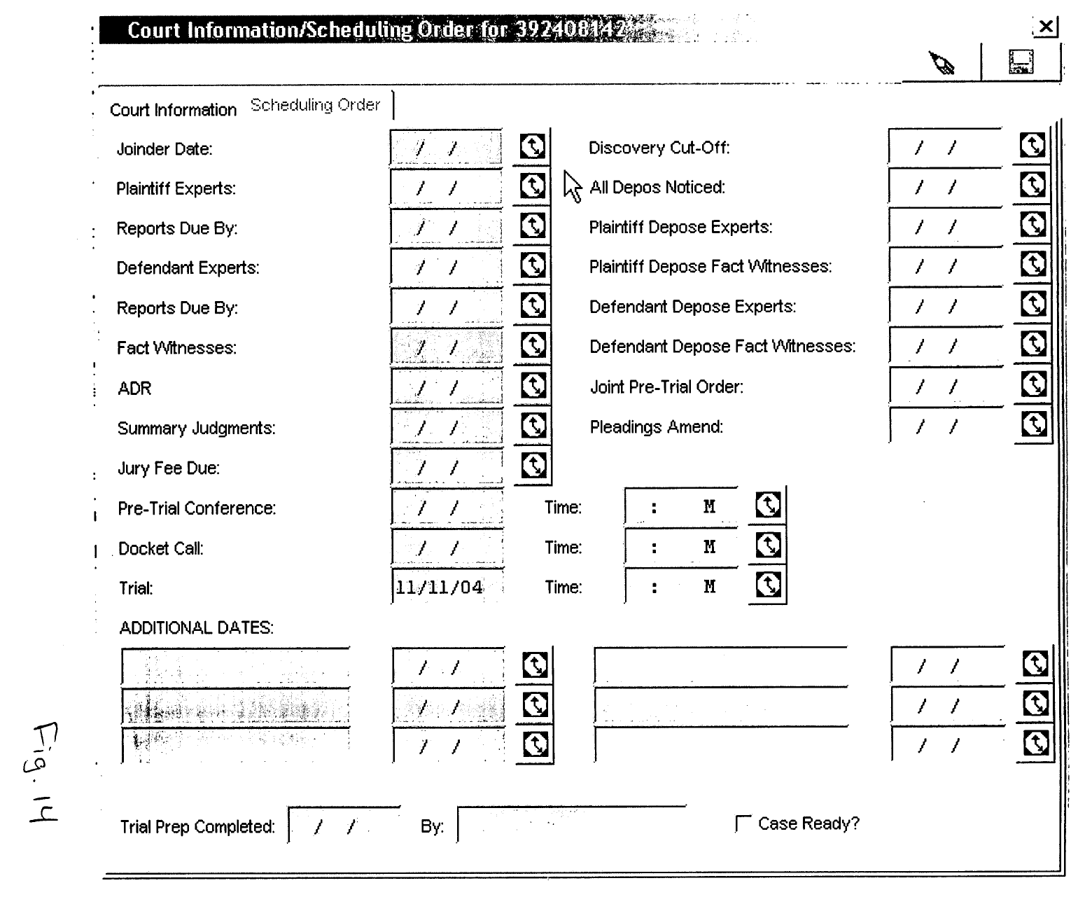

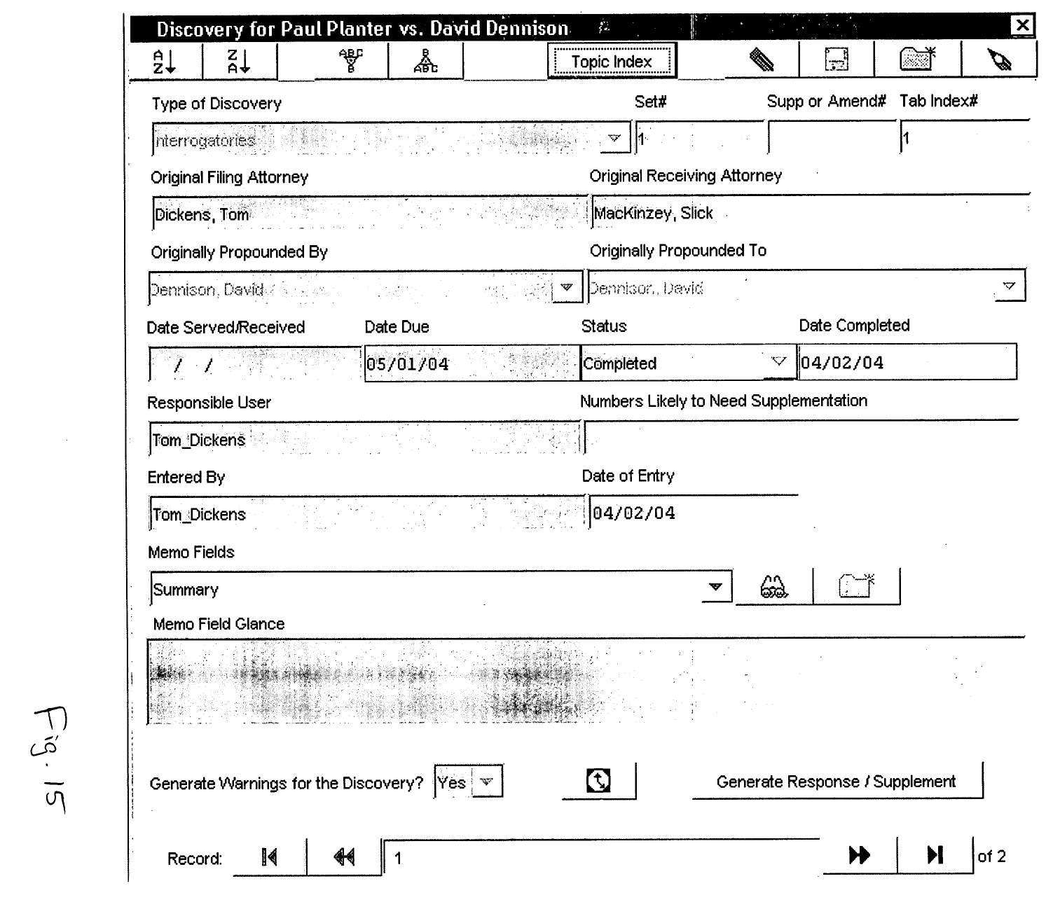

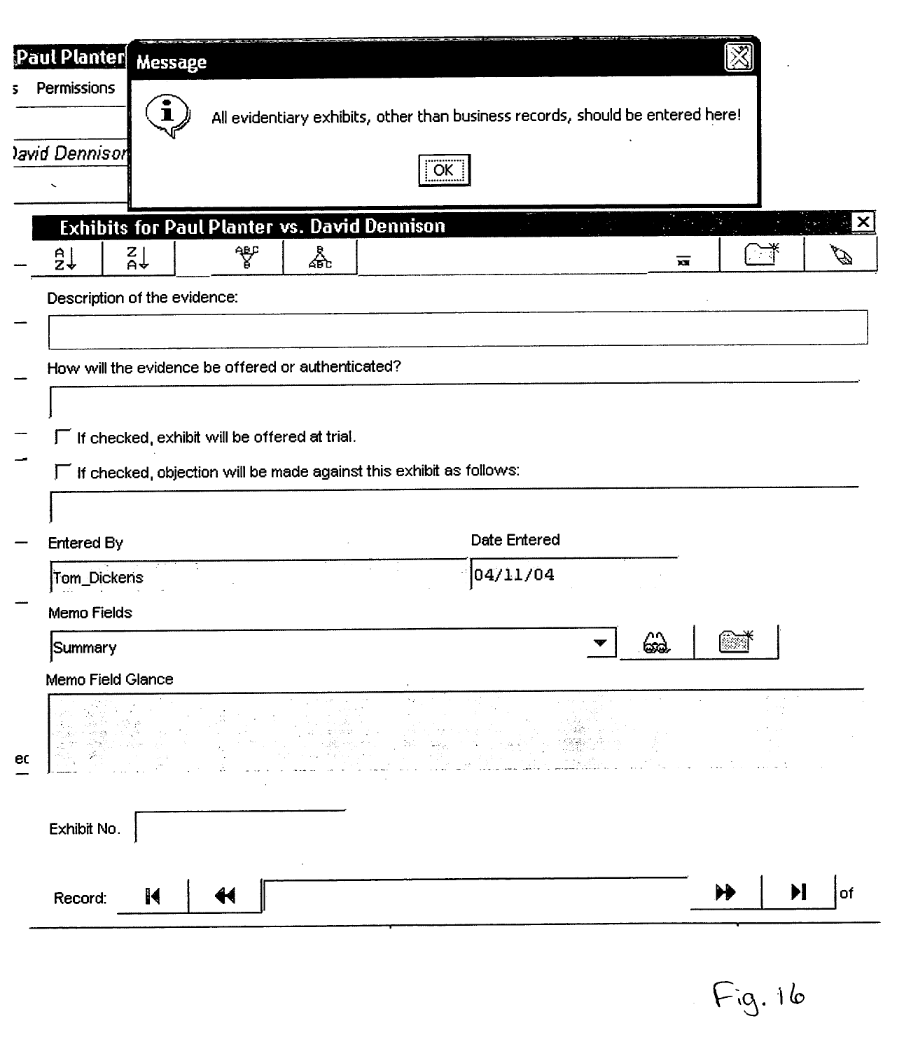

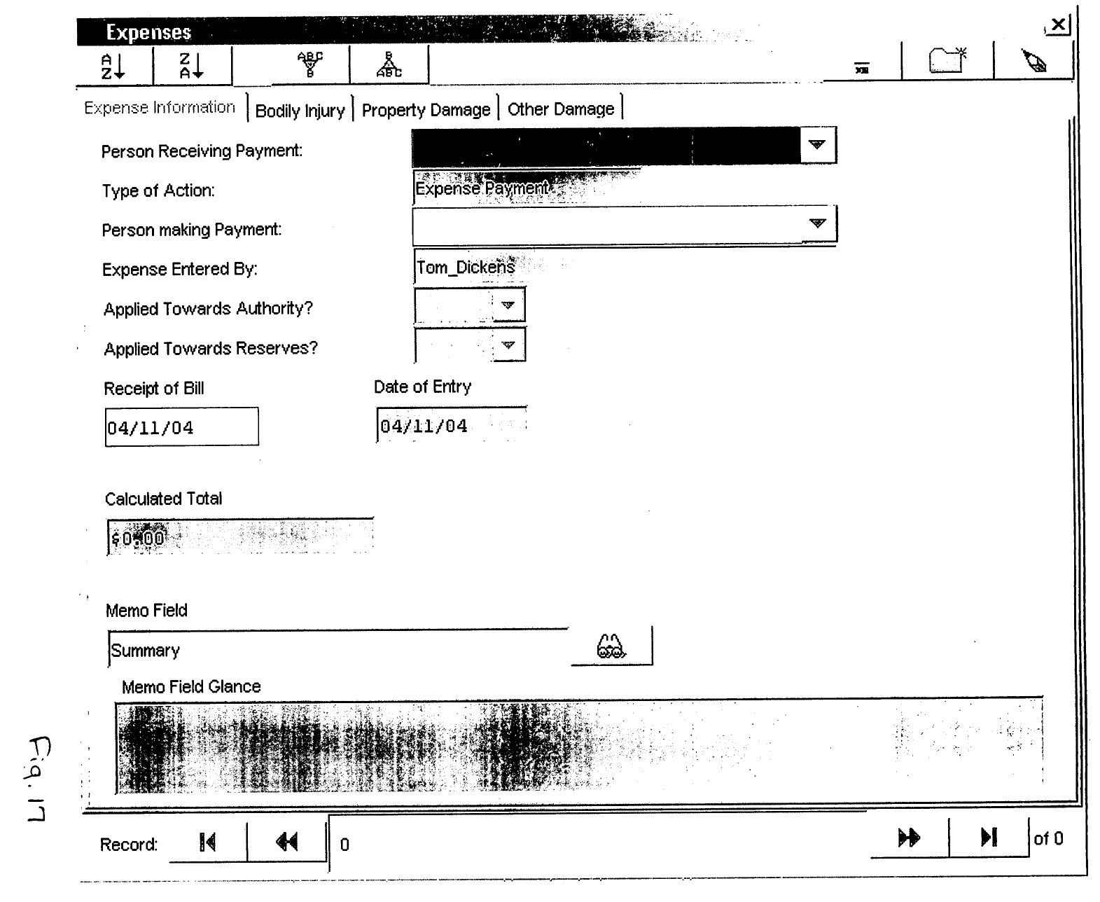

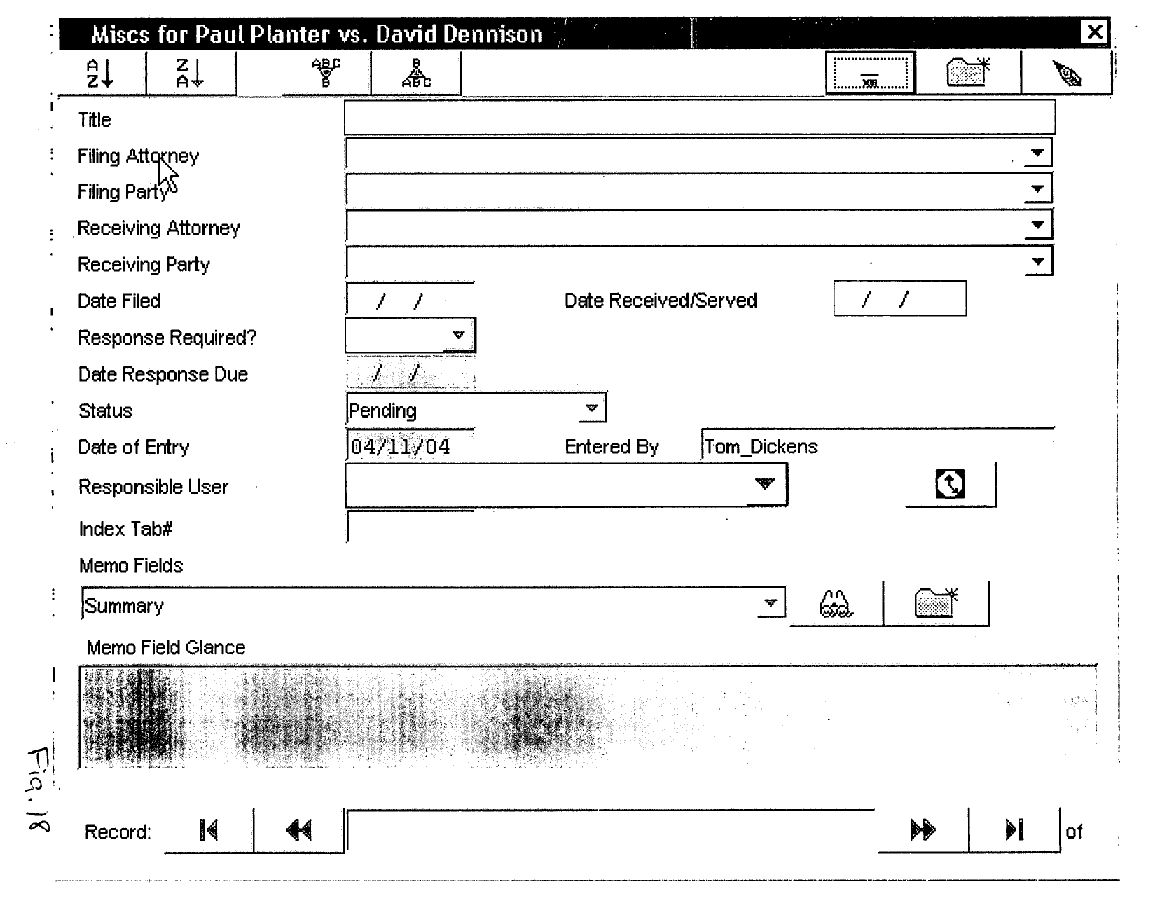

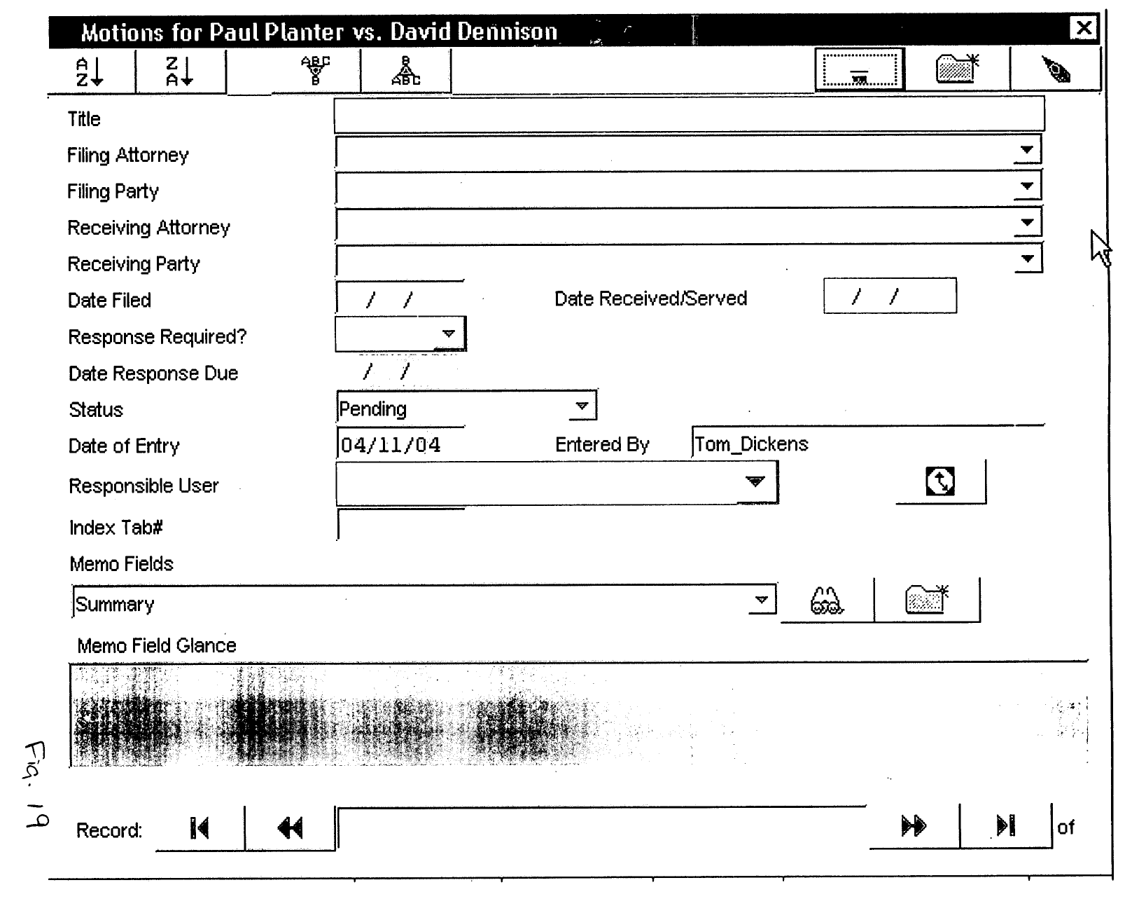

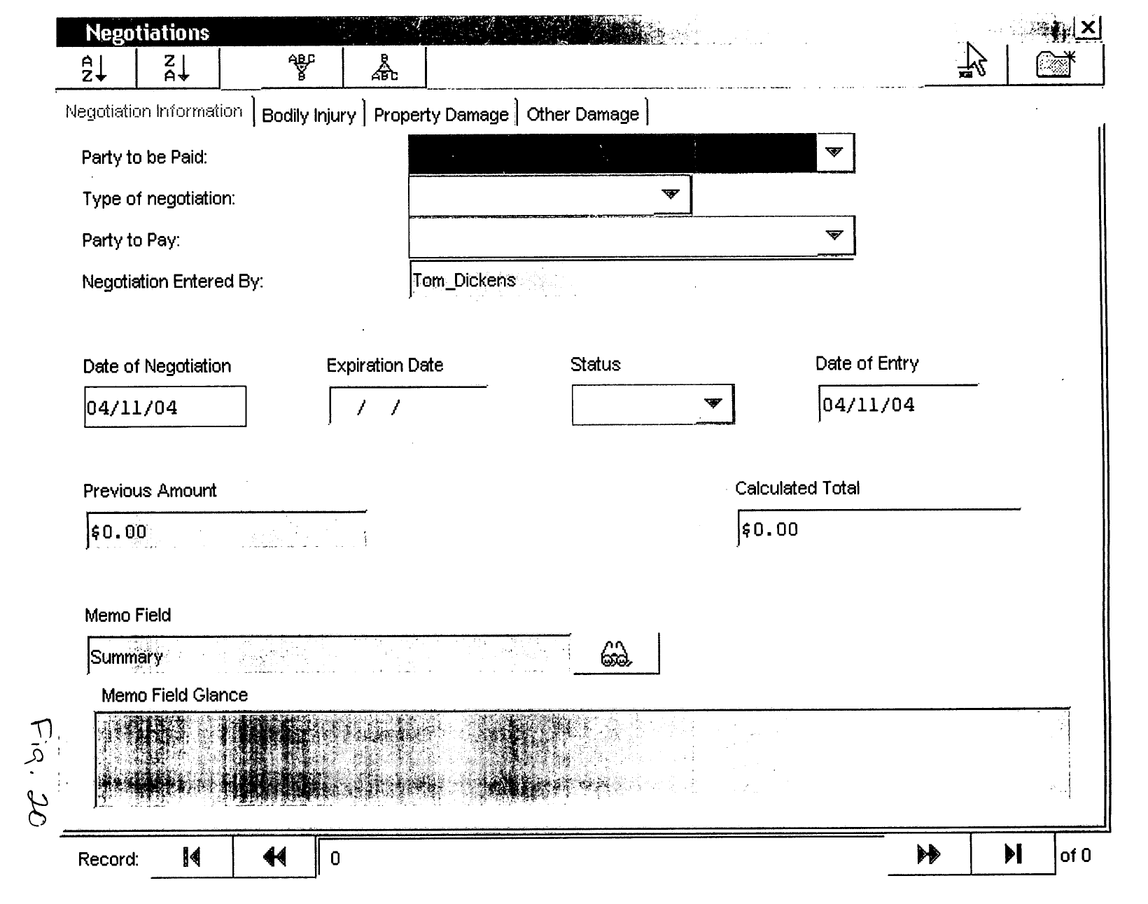

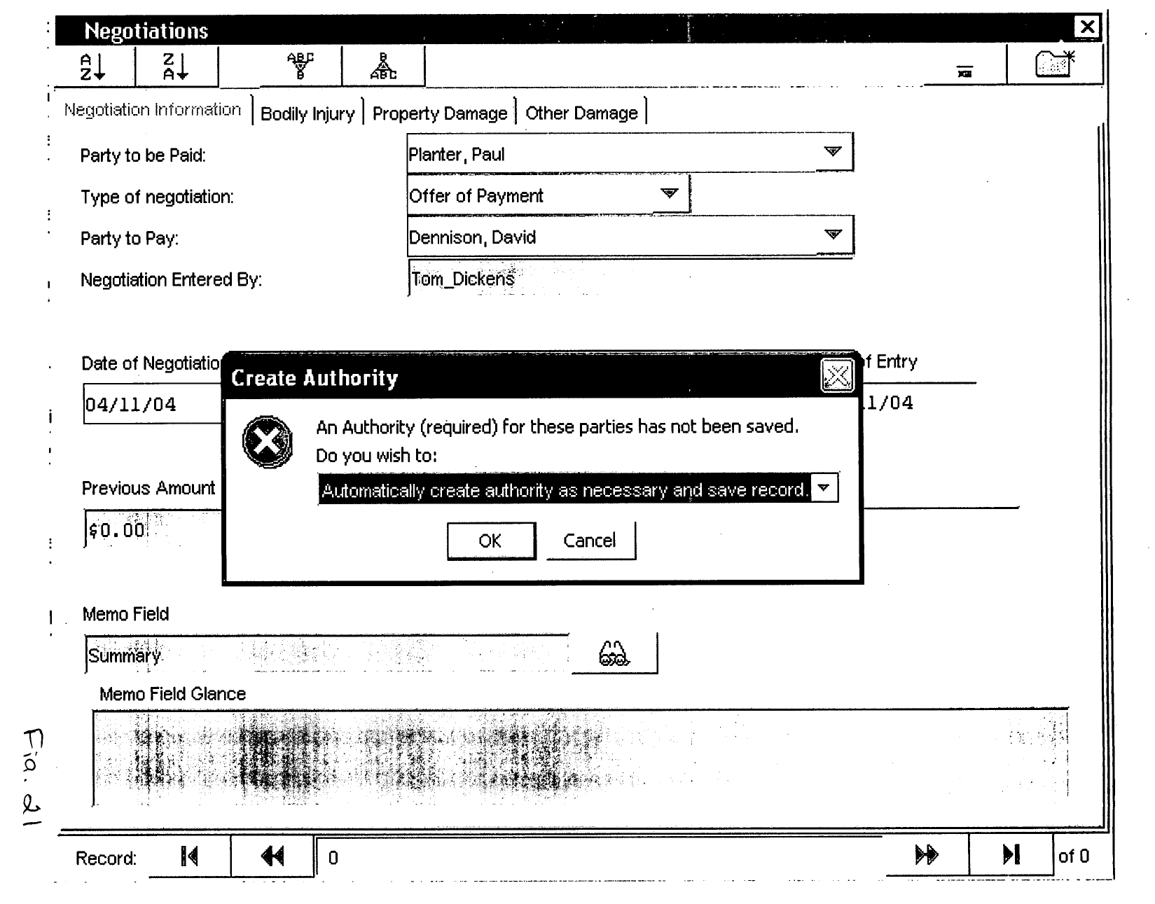

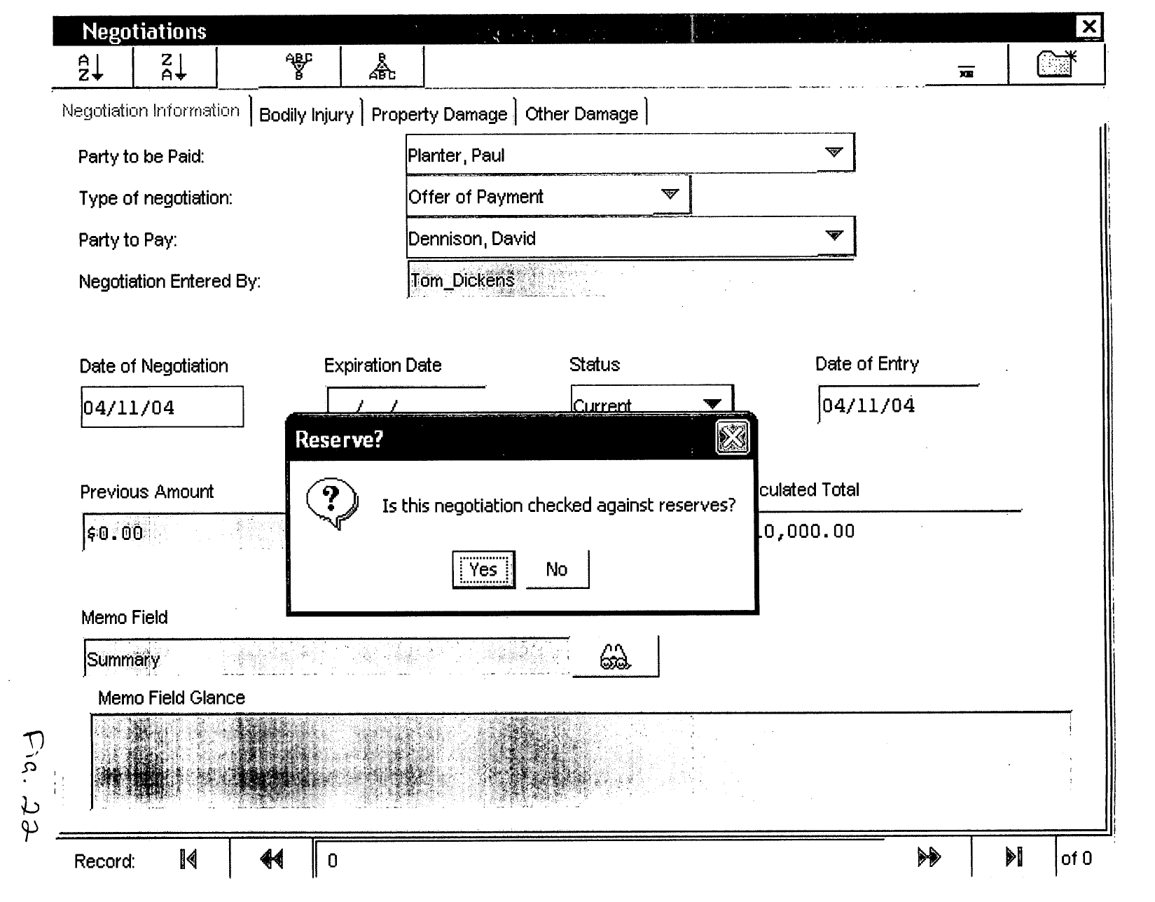

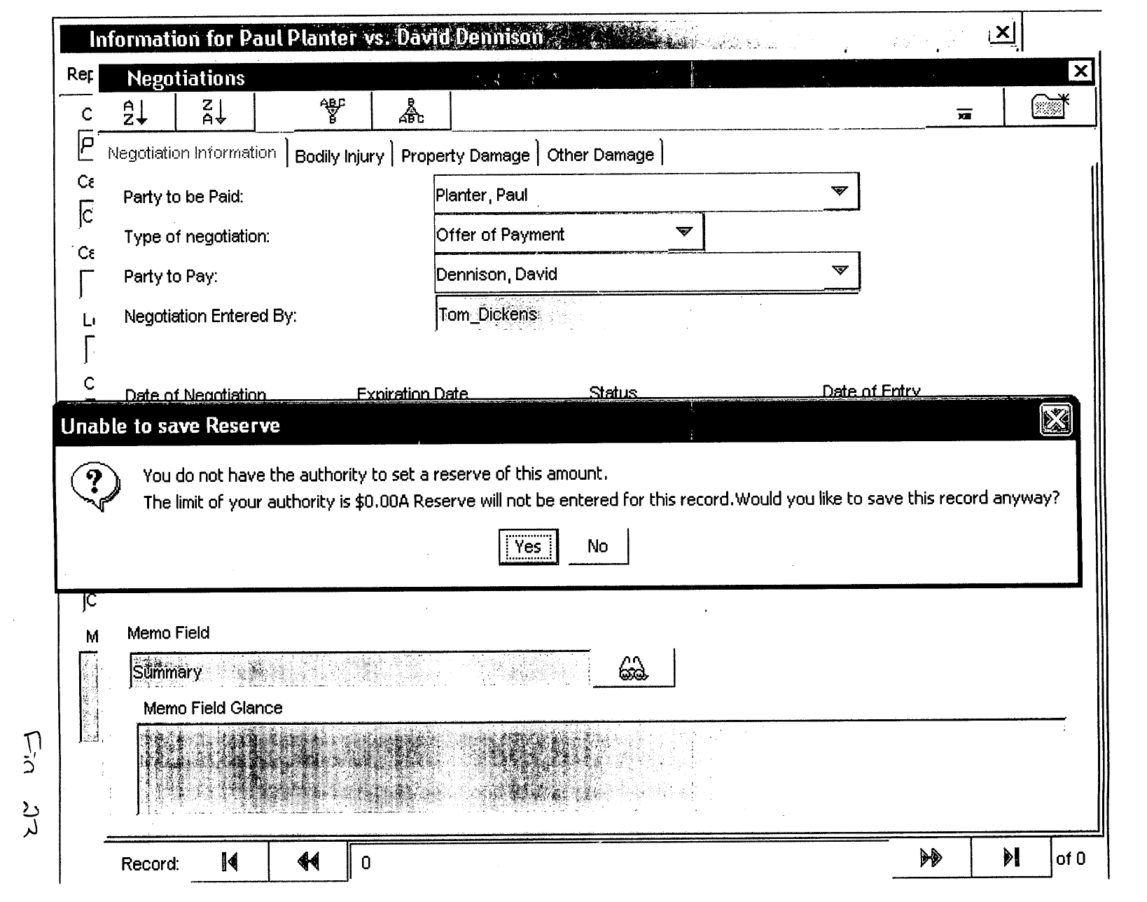

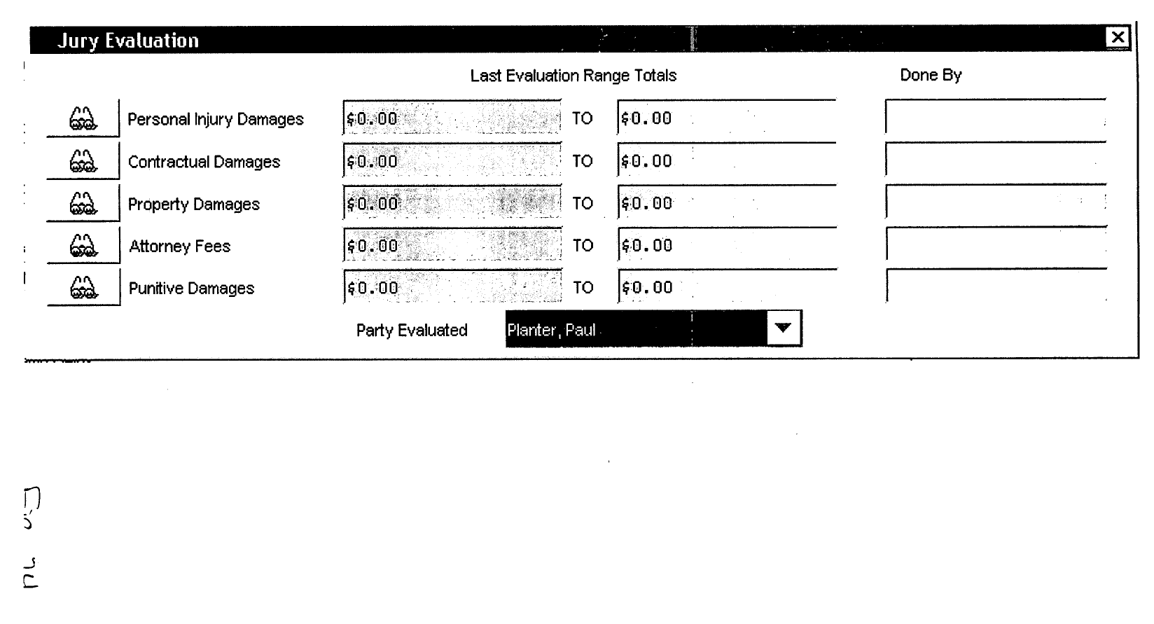

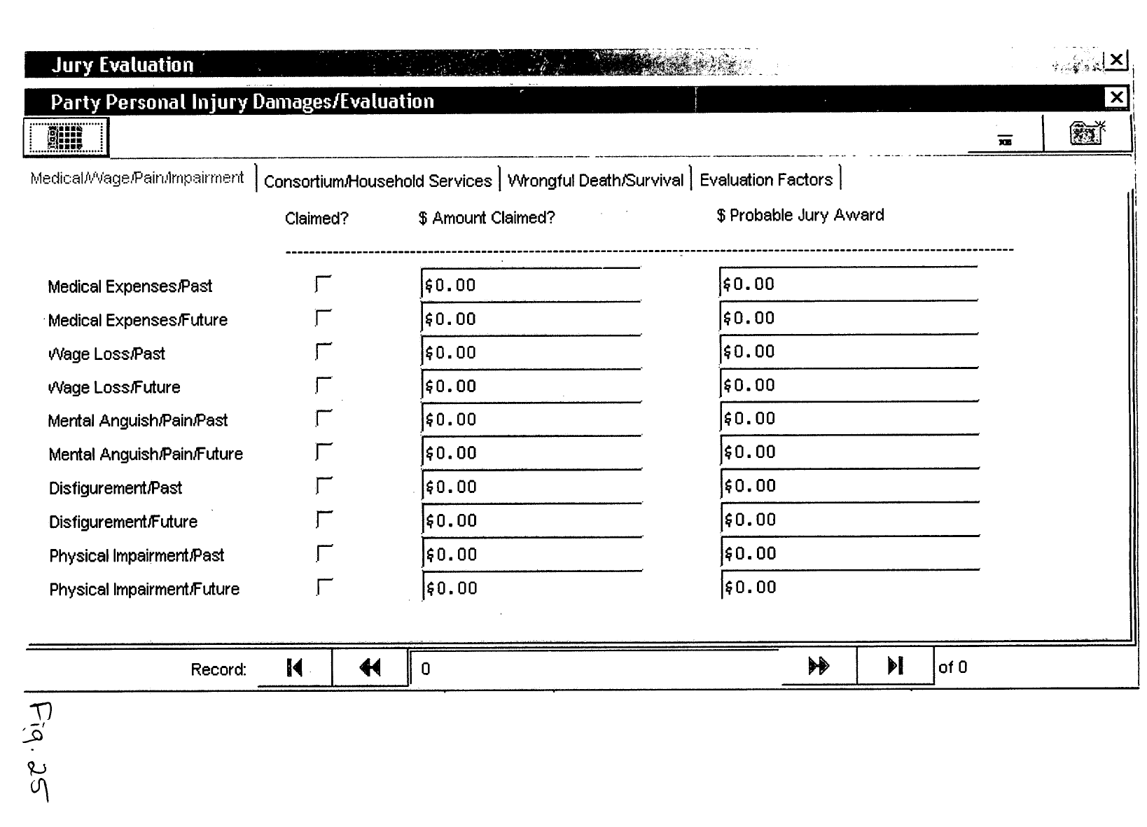

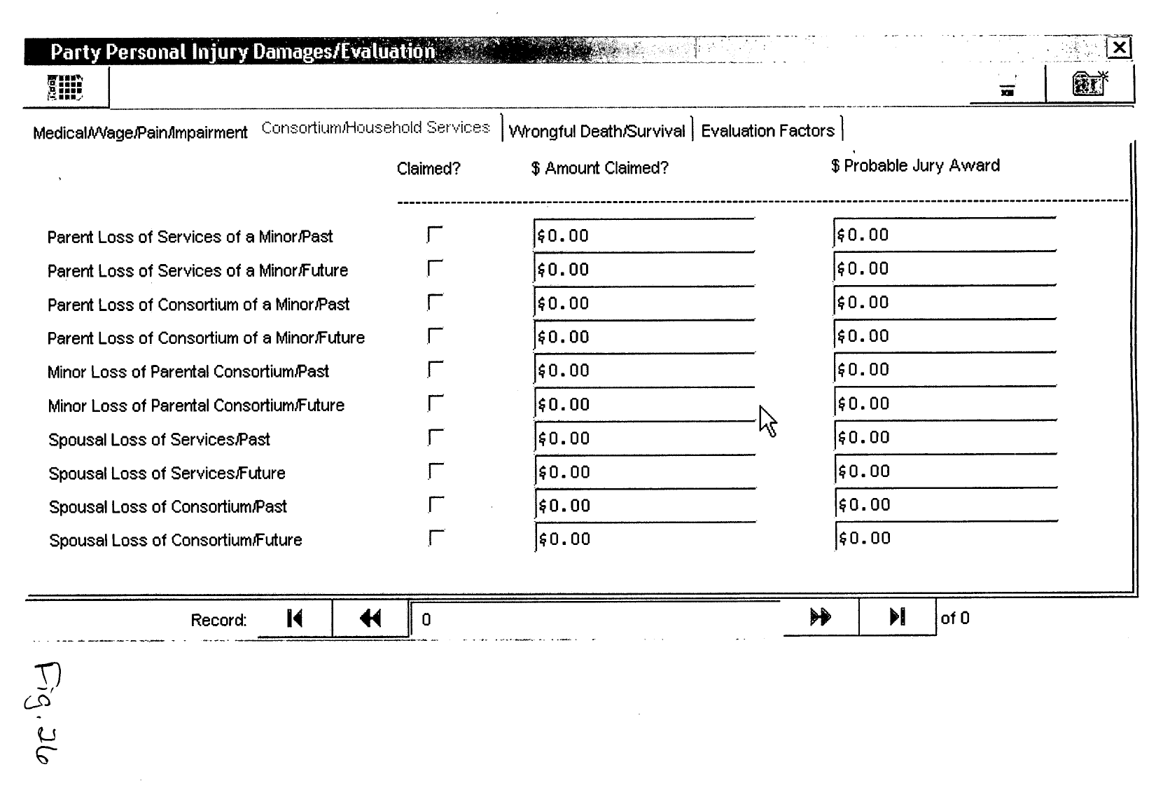

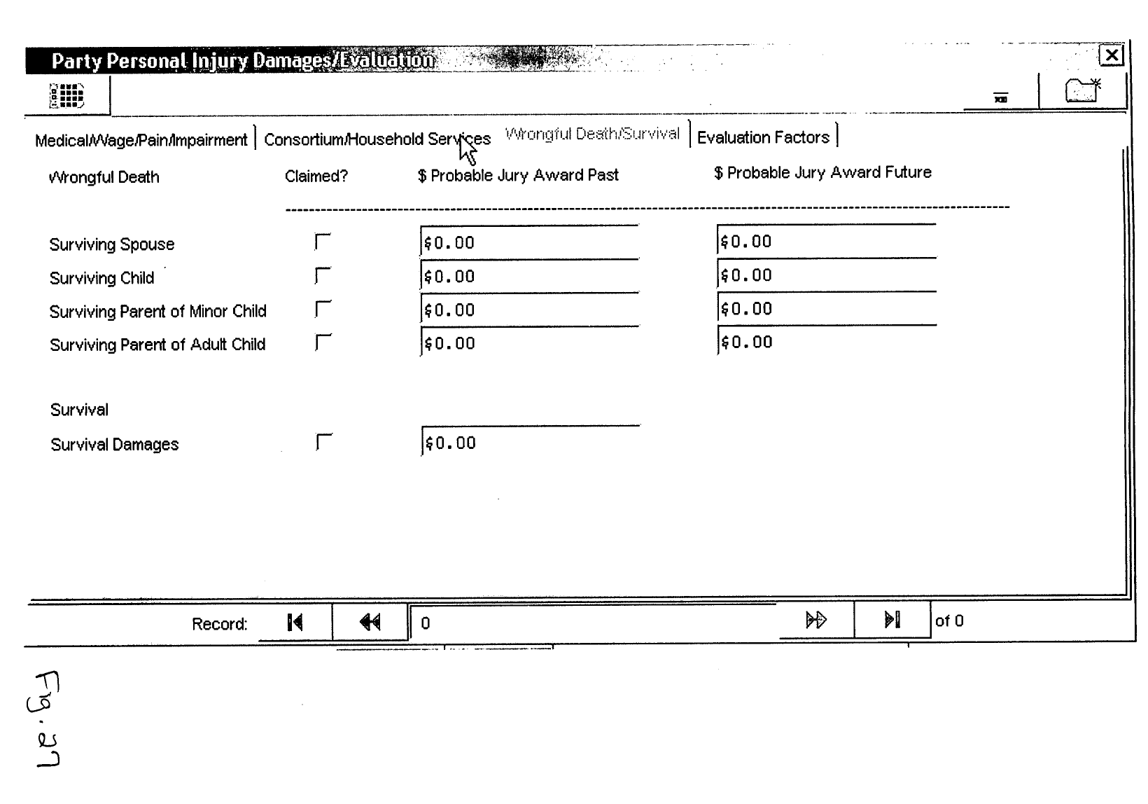

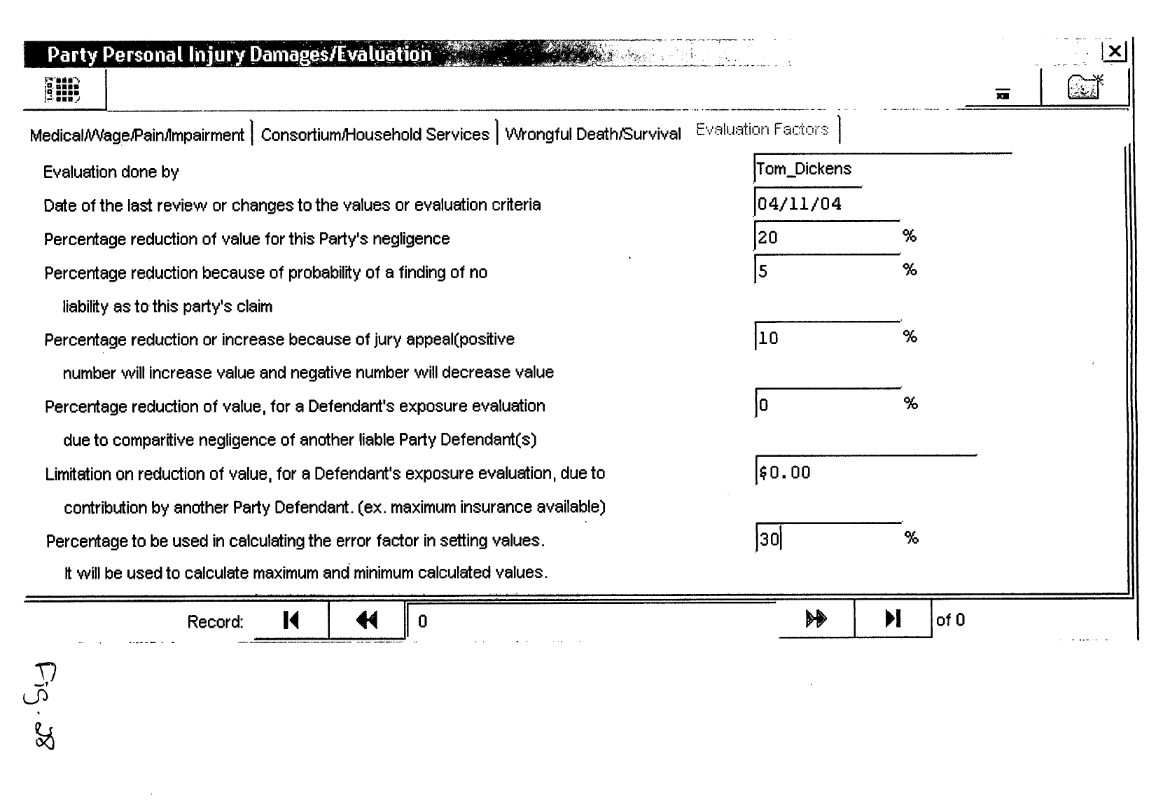

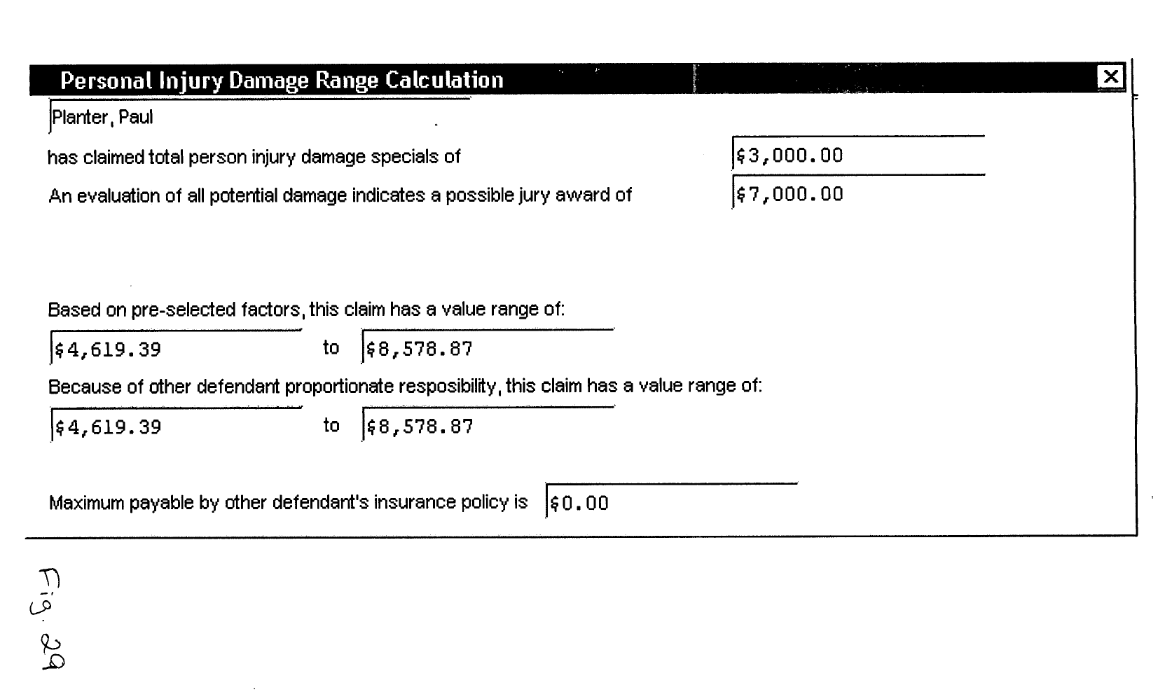

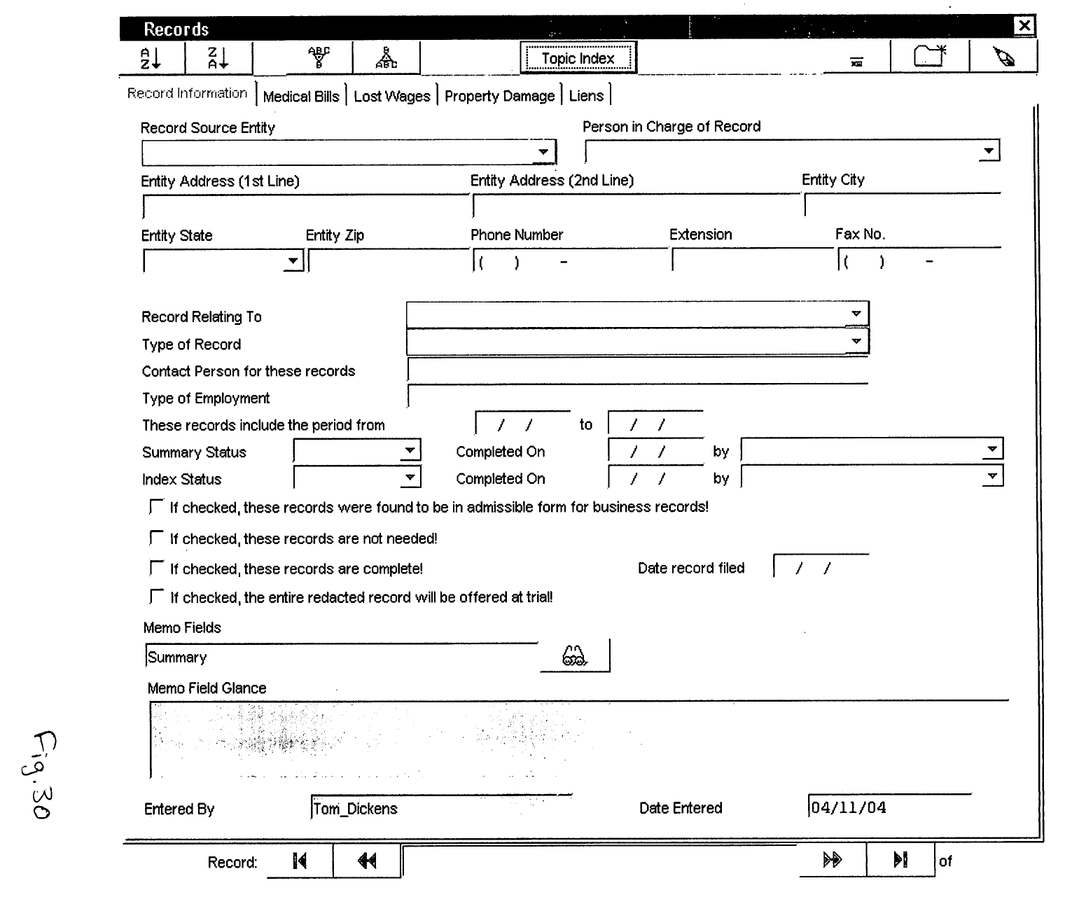

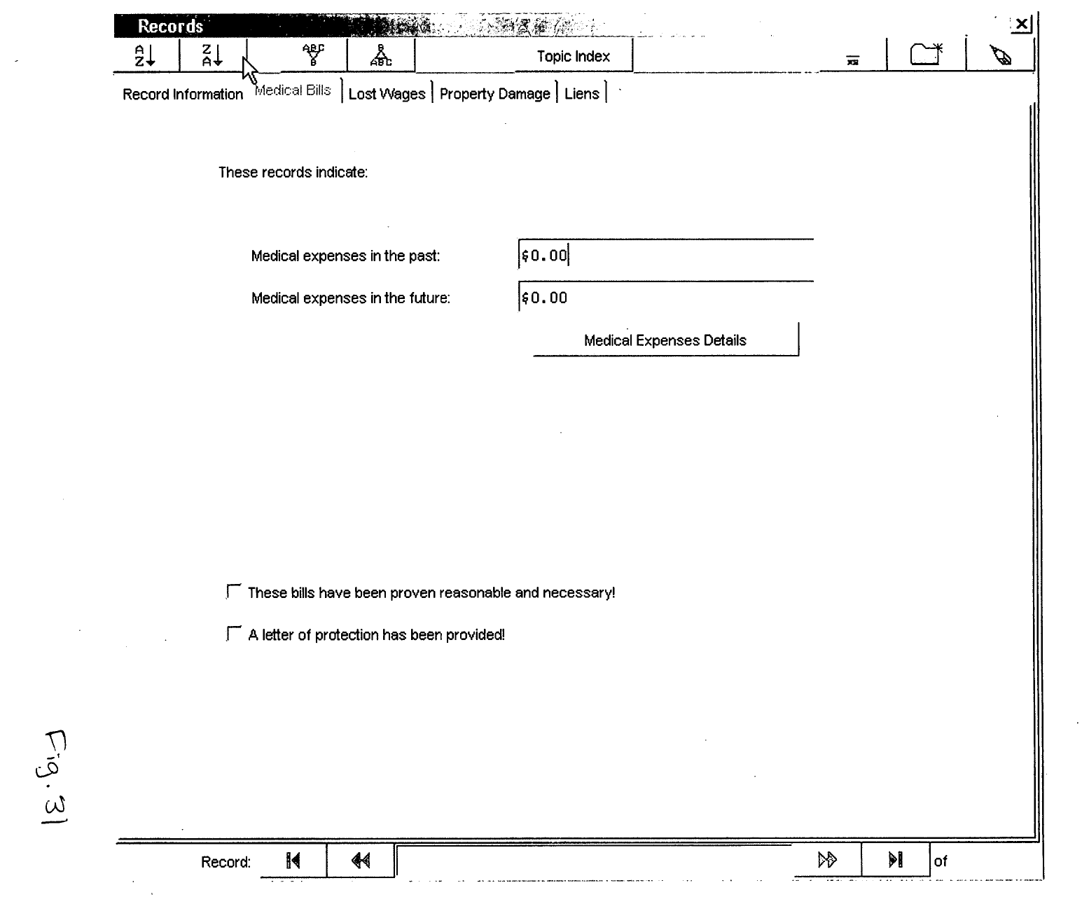

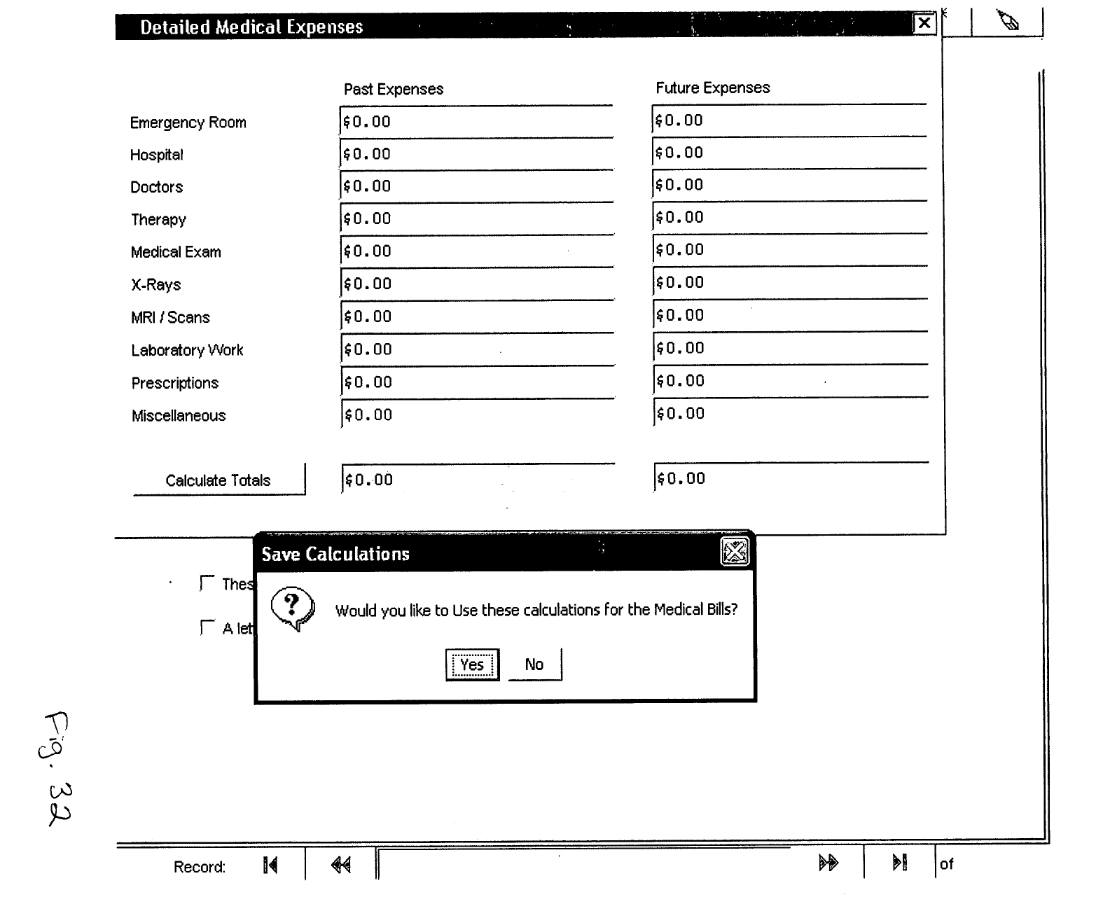

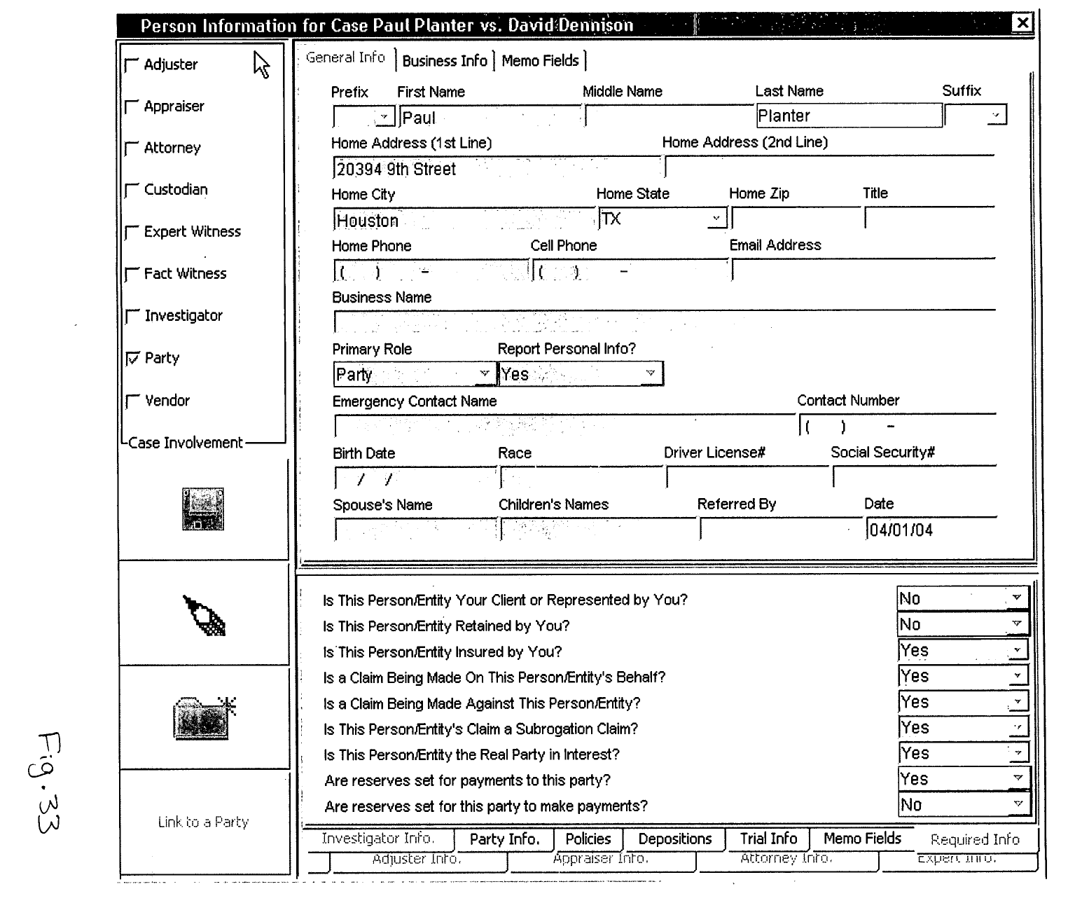

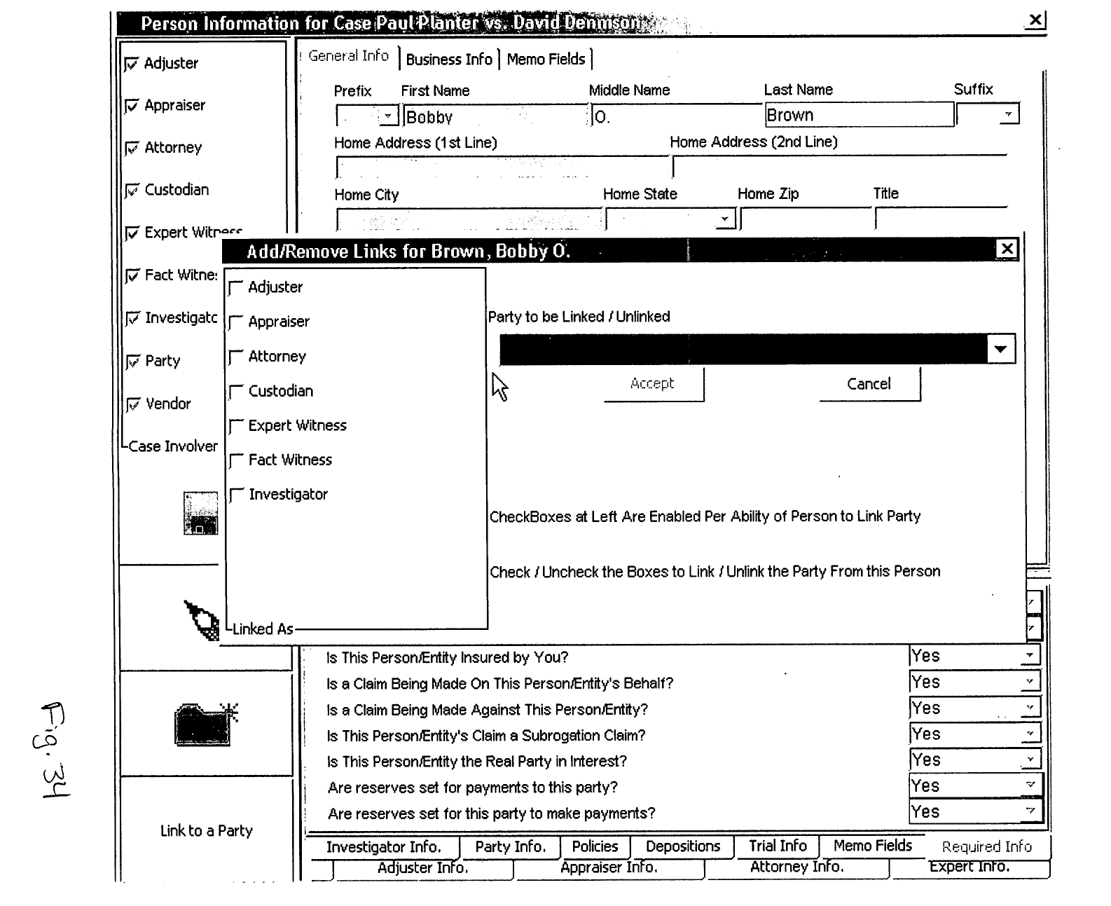

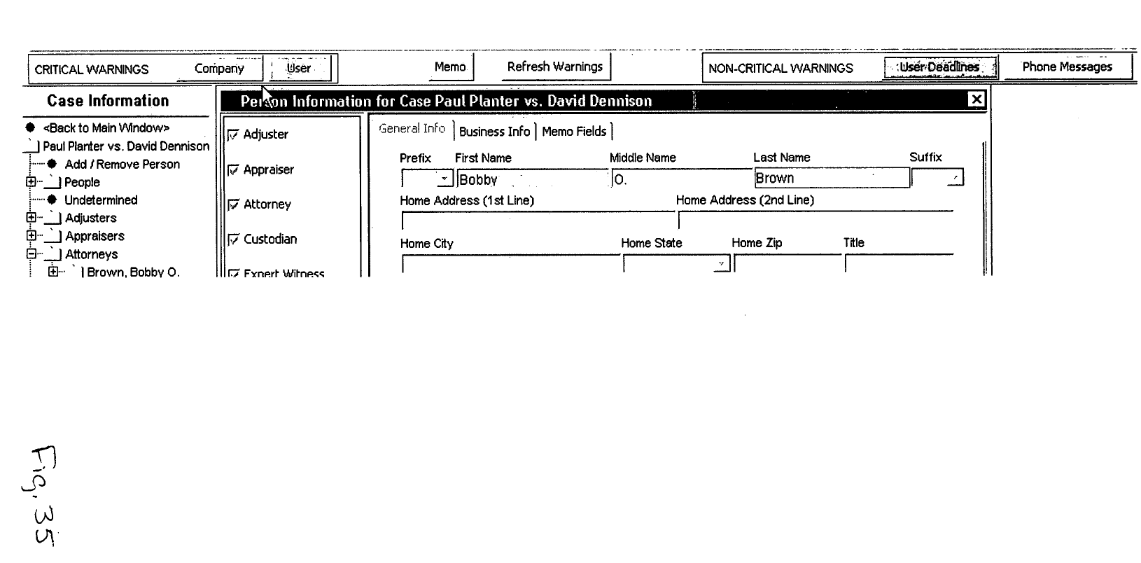

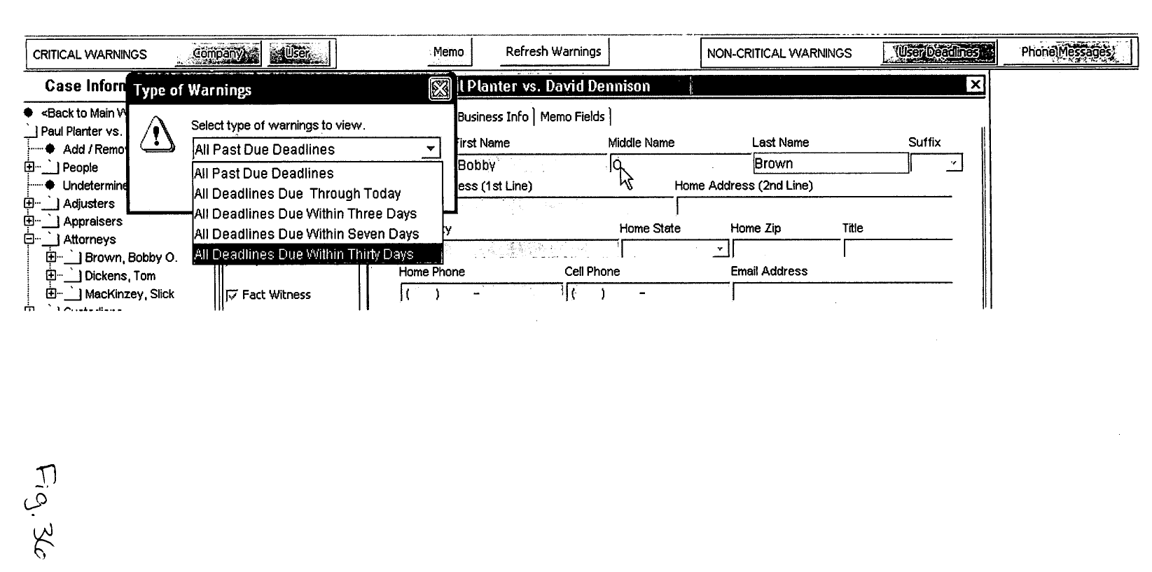

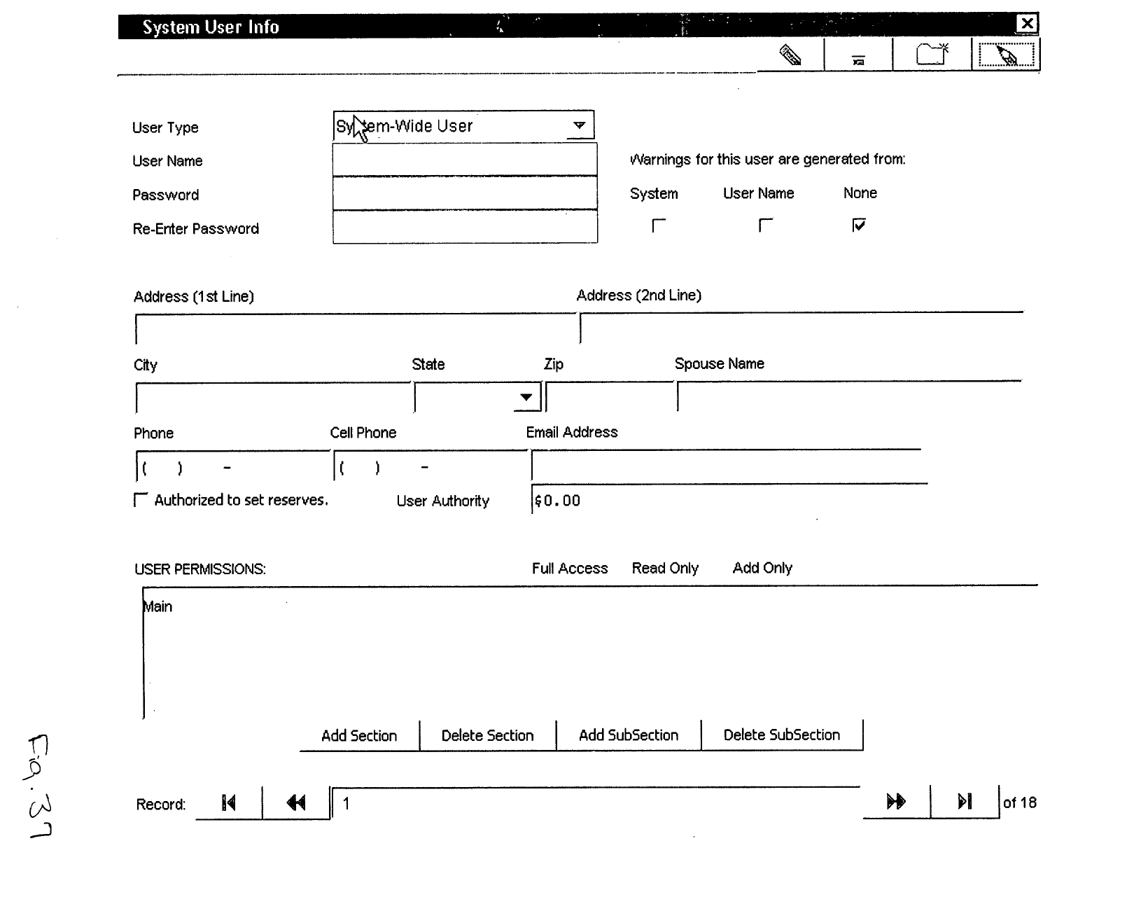

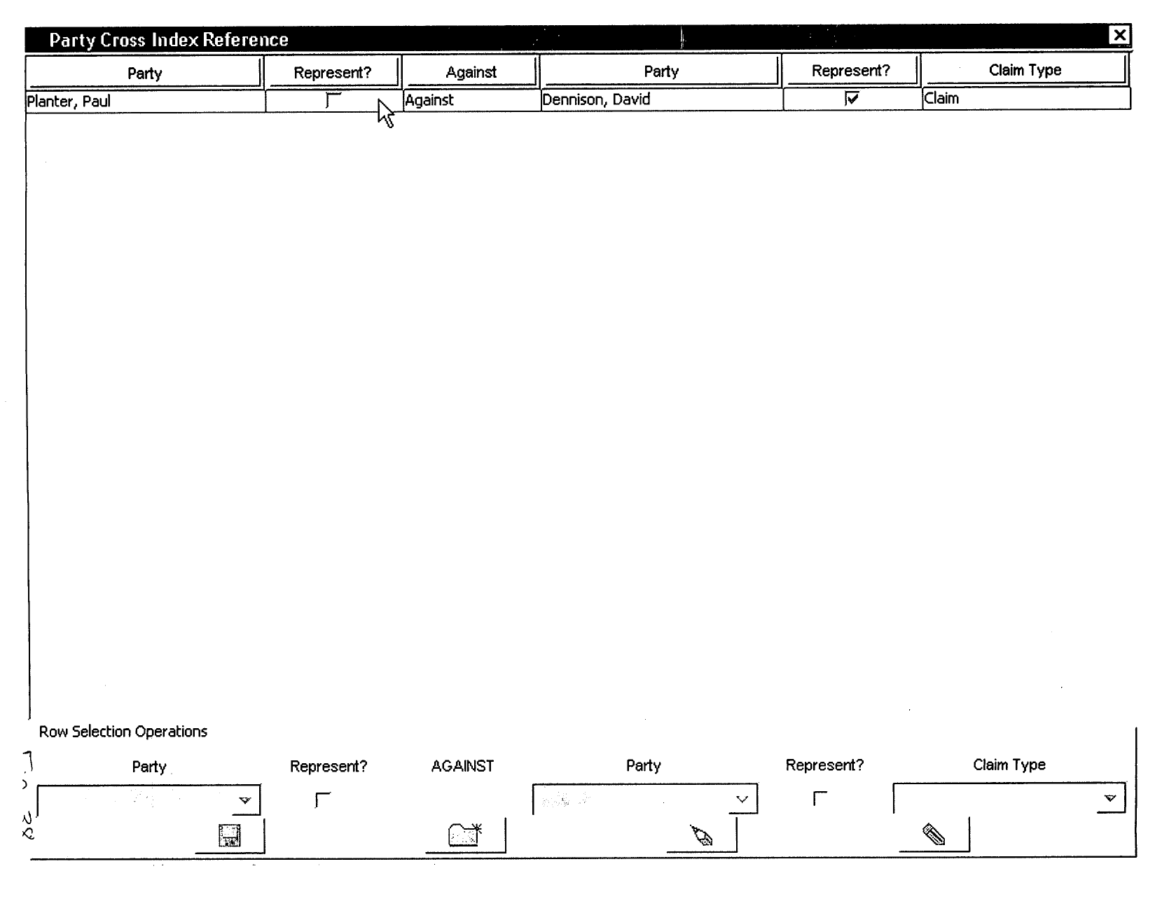

1. A method and a process, through internet based software, which can be utilized by and meets the specific needs of adjusters, attorneys and their clients (from the risk manager to the CEO) regarding contingent liabilities by allowing each to utilize the same software, comprised of a combination of full featured risk/claims management tools and full featured litigation management software, allowing their individual back ends for their data storage on the matters they are handling for multiple clients in a format which will provide each type of the tools they individually need for the development, handling, management, auditing, and reporting of contingent liabilities (claims and/or litigation) through the integration of tools, data management processes, and unique features comprising:
a. A method and a process for giving an individual remote secure controlled access to specific matters in an infinite variety of structures and being able to control the user's rights within the matter to full rights, view rights and add rights.
b. b. A method and a system for reporting information on selected matters from multiple back ends.
c. A method and a system for cross indexing parties and their claims against other parties.
d. A method and a process for the integration of the phone message system with the warning system and matter management billing system.
e. A method and a process for designing groups of fields and individual fields which can be both integrated into the individual matters as necessary including merge field indentification and use.
f. A method and a process for the integration of customized reports which can be added varibly from the website.
g. A method and a process for assigning a level of importance and therefore a level of notification of warnings for an activity that is due or deadlines which are approaching.
h. A method and a process for in-system memos which allow in-system communication that is related to and attached to the matter it references in which all users of the system can create and receive such memos.
i. A method and a process for displaying relationships of individual involved in the matter as they are connected to parties storing not only detailed party information but also storing detailed information on each individual involved in the matter and their relationship to each party, if any.
j. A method and a process for integrating case activities with menu task billing schedules and budgets which allows automatic correction of the entries at the point of original entry.
k. A method and a process for implementing ABA billing codes into a billing system that will allow automatic audits of legal bills to comply with budgest and menu task billing scheudles.
l. A method and a process for establishing budget items by an infinite number of categories which can be related to a case and automatically inported and relate specifically to the menu task billing schedules.
m. A method and a process for maintining court information and scheduling order information which will be automatically added to the diary system with both the original dates and variable additional preliminary warning dates for the court deadlines.
n. A method and a process for integrating a data information system which utilizes the information regarding pleadings, discovery, motions, and other documents to create system warnings and automatically generate index cover sheets.
O. A method and a process for recording, indexing and integrating information from various documents into a system for reporting, creating exhibit offers, creating exhibit objections, and information for use at trial both at pretrial, during the trial and for post trial motions.
p. A method and a process for evaluating the value of a party's claim which considers the elements of damages along with evaluation factors and a calculator that establishes a range of value meeting the requirements of financial reporting.
q. A method and a process for controlling the authority and the relationship among reserves, authority, negotiations and settlements to make certain that there is, for example, sufficient authority for negotiations; and, if there is not sufficient autority an automated process to increase authority in the amount required and regulate that adjustment by the authority of the individual making the entry as controlled by the system administrator.
r. A method and a system for creating finished documents from forms, including the ability to add variable fields to individual cases, that can be utilized in the document generator feature without any additional programming; and, the same information data fields within the multitude of tables which is used for remote client audits are the same fields that are available for use with the document generator thereby allowing multiple utilization of the same data.
s. A method and a process for documenting memo fields to ensure a client's ability to be able to verify the exact date that information was first added to the memo field and date the memo field was last edited.
t. A method and a process through automated audit reports and automated control features to control reserves, authority, negotiations, and settlements and ensure there is reasonable documents to support those activities;
u. A method and a process through automated audit reports and automated control features that there is a reasonable relationship between evaluations and settlements;
v. A method and a process through automated audit reports and automated control features that all activites and billing entries which are limited by menu task guidelines are strictly limited to those amounts and those limits are applied at the point of entry giving the user notice of same.
w. A method and a process through automated audit reports and automated control features that all activities limited by budget restraints are strickly limited to those budget restraints and those limits are applied at the point of entry giving the user notice of same.
x. A method and a process through automated audit reports and automated control features that all activities controlled by menu task billing codes provide standardized billing language as set by the client or the firm.
y. A method and a process through automated audit reports and automated control features in which all activities requiring preauthorization by the client has been so authorized prior to the activity that was performed;
z. A method and a process through automated audit reports and automated control features that ensure that all court and client deadlines are met;
aa. A method and a process through automated audit reports and automated control features that ensure that all relevant records are obtained, summarized and indexed timely;
bb. A method and a process through automated audit reports and automated control features that ensure that discovery must be obtained, summarized and indexed timely;
cc. A method and a process through automated audit reports and automated control features that ensure that evaluations are done on a timely basis and supported, on specific points, by records which have been obtained and summarized.
dd. A method and a process through automated audit reports and automated control features that ensure that a client can produce the attorney and/or adjusters bill and it will include automatic audit reports showing performance compliance and compliance with budgets and menu task billing guidelines.
ee. A method and a process through automated audit reports and automated control features tha will ensure that when evaluations change by more than client defined percentage there must be a justificaiton in a defined memo field.
ff. The contents of the Description of the Drawings, FIG. 1-40, are incorporated herein by reference the same as if appearing at length.

2. A method and a process, through internet based software, for an SEC listed company who reports contingent liabilities on their balance sheet and employs attorneys and adjusters (independent and staff) to handle those contingent liabilities to: (1) Independently, remotely and securely audit and review information, facts, and opinions, both current and historical, on each pending contingent liability worldwide, both claims and litigation; (2) Implement and enforce controls regarding the handling of those contingent liabilities; (3) Monitor the effectiveness of those controls; (4) Report on the level of effectiveness; (5) Document all remedial measures taken as a result of that monitoring process; (6) Export the data and information relevant to these measures and steps in a format compatible with the requirements of auditors;
and, (7) Meet the requirements of The Sarbanes-Oxley Act of 2002 for such contingent liabilities, comprising the steps of:
a. The contents of claim #1 (a-ee) are incorporated herein by reference the same as if appearing at length;
b. The contents of the Description of the Drawings, FIG. 1-40, are incorporated herein by reference the same as if appearing at length.

3. A method and a process, through Internet based software, for a law firm or adjusting company (third party administrator of claims) to: (1) Allow multiple clients direct, secure, remote, independent and controlled access 24/7 to the information, including opinions, facts, work product and key word processing documents, on their cases only [references to cases includes both litigation and non-litigation matters], as that information is developed by the firm as the matters are being handled regardless of how many clients' cases are being handled by the firm or company with the software; (2) Control the clients' rights so the clients an have access to their cases only; (3) Control the clients' rights within their cases or individual cases by controlling whether the client has the right to only view information, view and add information, or full rights within the case giving them the right to view, add and edit records; (4) Allow the client to remotely, securely and independently generate a variety of reports including, but not limited to, reports showing the firm's performance regarding the client's cases, automatically audited legal bills, status reports, exceptions reports, deadline compliance reports, budget compliance reports, preauthorization compliance reports, menu task billing compliance reports, and other key performance compliance reports comprising the steps of:
a. The contents of claim #1 (a-ee) are incorporated herein by reference the same as if appearing at length;
b. The contents of the Description of the Drawings, FIG. 1-40, are incorporated herein by reference the same as if appearing at length.

4. A method and a process for the analysis, indexing, summarizing, and reporting on information contained in records, pleadings, discovery, statements, depositions and statements in fixed and variable topic format that provides that information in a format that can be used for pre-litigation evaluation and for litigation use in pretrial discovery, trial preparation of offers and objections to evidence, and use in trial for examination of witnesses comprising the steps of:
is a. The contents of claim #1 (a-ee) are incorporated herein by reference the same as if appearing at length;
b. The contents of the Description of the Drawings, FIG. 1-40, are incorporated herein by reference the same as if appearing at length.

5. A method and a process, through software, a billing and accountability system for attorneys and/or adjusters that allows an individual matter to be associated or linked to one of an infinite number of custom (created by the firm or the client) menu task billing guidelines and associated budget schedule which allows the client or employer to remotely, securely and independently generate bills, audit reports and status reports which incorporates the requirement of the selected menu task billing guidelines or schedule into a system and method which will correct entries at the point of entry for compliance with menu task billing guidelines, budgets, and pre-approval authorization requirements; as well as, generate audit reports which will demonstrate compliance with the selected menu task billing guidelines, budgets, pre-approval authorization requirements, billing increment guidelines, performance criteria, deadlines, matter development guidelines, and reporting requirements; all of which can be done regardless of where the matter is pending comprising the steps of:
a. The contents of claim #1 (a-ee) are incorporated herein by reference the same as if appearing at length;
b. The contents of the Description of the Drawings, FIG. 1-40, are incorporated herein by reference the same as if appearing at length.
